(19) United States
(12) Patent Application Publication
(10) Pub. No.: US 2003/0022657 A1
(43) Pub. Date: Jan. 30, 2003

(54) Application provisioning over a wireless network

(76) Inventors: Mark Herschberg, Cambridge, MA (US); Lawrence Wang, Tarzana, CA (US); Arvind K. Goyal, Sudbury, MA (US)

Correspondence Address: PENNIE & EDMONDS LLP, 1667 K STREET NW, SUITE 1000, WASHINGTON, DC, 20006

(21) Appl. No.: 09/908,343

(22) Filed: Jul. 18, 2001

(51) Int. Cl. H04M 3/42

(52) U.S. Cl. 455/414; 455/412; 455/419

(57) ABSTRACT

A system and method for managing application provisioning to one or more wireless devices are disclosed. In a preferred embodiment, the system comprises a server framework that is adapted to communicate with one or more wireless devices of various types via a wireless communications network. An administration tool is preferably provided that permits an administrator to specify whether an application is required, optional, or unauthorized for individual users or user groups and whether an application is compatible with a specific type of user device. When a user attempts to log into the server framework from his or her wireless device, the system automatically downloads all compatible required applications to the user's device and deletes all unauthorized downloaded applications from the user's device. It also gives the user the opportunity to download any optional applications that are compatible with the user's device.

### BACKGROUND OF THE INVENTION

The market for personal digital assistants (PDAs) continues to grow as more and more people recognize the convenience of carrying a single device that can run a variety of applications and store many different types of useful information. A single PDA, for example, may run a calendar application that stores a user's appointments, an address book application that stores phone numbers and addresses of the user's personal and professional contacts, and a memo pad application that may be used to create and store short documents.

Many PDAs are sold with a cradle that allows the PDA to connect to a PC or other computer. When mounted in the cradle, the PDA can synchronize data from one or more of its applications with data stored by corresponding applications on the PC. For example, if the user updates a phone number in his or her PDA address book application, that updated phone number may be automatically transmitted via the cradle to the PC and used to update a corresponding address book application resident on the PC.

Some PDAs also have wireless-communication capability that permits them to transmit and receive data via a wireless network. The wireless connection may be used to transmit and receive many different types of information. For example, many wireless-enabled PDAs comprise a Web browser to permit the user to download and display Web pages from the Internet. Others use the wireless connection to transmit and receive e-mail.

Another use of the wireless connection is to download applications to the PDA. In some systems, the PDA transmits a request for a particular application to a remote server which responds by downloading the requested application to the PDA via a wireless connection. In other systems, the remote server may identify an application and push the application to the PDA when a wireless connection is established. These systems, however, cannot efficiently manage application provisioning generally to a plurality of different PDAs, especially when the number and variety of downloaded applications are significant.

### SUMMARY OF THE INVENTION

A system and method for managing application provisioning to one or more wireless devices is disclosed. In a preferred embodiment, the system comprises a server framework that is adapted to communicate with one or more wireless devices of various types via a wireless communications network. Each of the wireless devices is adapted to store and run one or more downloaded applications received via the wireless network.

An administration tool is preferably provided that permits an administrator to control downloading of applications to particular wireless devices and track the applications resident on those devices. In particular, the tool is designed to permit the administrator to define records for individual users, user groups, and device types, and to establish, on an application by application basis, permission settings for each user, user group, and device category.

More specifically, for each downloadable application, the administrator preferably specifies whether (1) the application must be downloaded to all system users (referred to as a “system required” application), (2) the application must be downloaded to specific system users or members of specific user groups (referred to as a “required” application), (3) the application may (at the user's request) be downloaded to specific system users or members of specific user groups (referred to as a “grant” or “optional” application), or (4) the application may not be downloaded to (and must be deleted from) specific system users or members of specific user groups (referred to as a “deny” or “unauthorized” application). In addition, the administrator preferably specifies the particular device types that are compatible with each downloadable application.

The term “download” is used herein to generically describe transmitting an application (or other data) to a wireless device. Those skilled in the art will recognize that such “downloading” may be achieved in a variety of ways. For example, an application may be pushed to a wireless device by a server. Alternatively, the application may be downloaded by the wireless device from the server.

When a user attempts to log into the server framework from his or her wireless device, the device transmits a list of downloaded applications that are resident on the device to the server framework. The server framework retrieves the user's permission settings from memory and identifies downloadable applications that must, may, or may not be made available to the user. System required and required applications that are compatible with, and not already resident on, the user's device are downloaded and installed on the user's device. Optional applications that are compatible with, and not already resident on, the user's device are downloaded and installed on the user's device if requested by the user.

Unauthorized applications are automatically deleted from the user's device.

### BRIEF DESCRIPTION OF THE DRAWINGS

The above summary of the invention will be better understood when taken in conjunction with the following detailed description and accompanying drawings, in which:

FIG. 1A is a block diagram that shows a preferred embodiment of a suitable architecture for practicing the present system and method;

FIG. 1B is a block diagram of a second preferred embodiment of a suitable architecture for practicing the present system and method;

FIG. 2 is a block diagram of a preferred embodiment of a wireless device;

FIG. 3 is a block diagram of a preferred embodiment of a server framework;

FIG. 4 is a flow diagram showing a preferred embodiment for maintaining user categories and establishing permission settings;

FIG. 5 shows a preferred embodiment of a login screen of an administration tool;

FIG. 6A shows a preferred embodiment of a setup screen of the administration tool;

FIG. 6B shows an alternative preferred embodiment of a login screen of the administration tool;

FIG. 7A shows a preferred embodiment of a main screen of the administration tool;

FIG. 7B shows an alternative preferred embodiment of a main screen of the administration tool;

FIG. 8 shows a preferred embodiment of a main screen of the administration tool when “users” is selected;

FIG. 9 shows a preferred embodiment of an add user dialogue screen of the administration tool;

FIG. 10 shows a preferred embodiment of a remove user confirmation screen of the administration tool;

FIG. 11 shows a preferred embodiment of a user property dialogue screen of the administration tool;

FIG. 12 shows a preferred embodiment of another user property dialogue screen of the administration tool;

FIG. 13 shows a preferred embodiment of another user property dialogue screen of the administration tool;

FIG. 14 shows a preferred embodiment of another user property dialogue screen of the administration tool;

FIG. 15 shows a preferred embodiment of a main screen of the administration tool when “groups” is selected;

FIG. 16 shows a preferred embodiment of a screen of the administration tool where groups can be added;

FIG. 17 shows a preferred embodiment of a main screen of the administration tool when “groups” is selected;

FIG. 18A shows a preferred embodiment of a group property dialogue screen of the administration tool;

FIG. 18B shows an alternative preferred embodiment of a group property dialogue screen of the administration tool;

FIG. 19 shows a preferred embodiment of another group property dialogue screen of the administration tool;

FIG. 20A shows a preferred embodiment of another group property dialogue screen of the administration tool;

FIG. 20B shows an alternative preferred embodiment of another group property dialogue screen of the administration tool;

FIG. 21 shows a preferred embodiment of a main screen of the administration tool when “devices” is selected;

FIG. 22 shows a preferred embodiment of a screen of the administration tool where devices can be removed;

FIG. 23 shows a preferred embodiment of a device properties dialogue screen of the administration tool;

FIG. 24A shows a preferred embodiment of another device properties dialogue screen of the administration tool;

FIG. 24B shows an alternative preferred embodiment of another device properties dialogue screen of the administration tool;

FIG. 25 shows a flow diagram of a preferred embodiment for registering a new wireless device;

FIG. 26 shows a preferred embodiment of a main screen of the administration tool when “device types” is selected;

FIG. 27 shows a preferred embodiment of an add device type dialogue screen of the administration tool;

FIG. 28 shows a preferred embodiment of a remove device type dialogue screen of the administration tool;

FIG. 29 shows a preferred embodiment of a device type properties dialogue screen of the administration tool;

FIG. 30 shows a preferred embodiment of another device type properties dialogue screen of the administration tool;

FIG. 31 shows a preferred embodiment of another device type properties dialogue screen of the administration tool;

FIG. 32 shows a preferred embodiment of a main screen of the administration tool when “applications” is selected;

FIG. 33A shows a preferred embodiment of an add application dialogue screen of the administration tool;

FIG. 33B shows an alternative preferred embodiment of an add application dialogue screen of the administration tool;

FIG. 34 shows a preferred embodiment of a remove application dialogue screen of the administration tool;

FIG. 35A shows a preferred embodiment of an application properties dialogue screen of the administration tool;

FIG. 35B shows an alternative preferred embodiment of an application properties dialogue screen of the administration tool;

FIG. 36 shows a preferred embodiment a new version application dialogue screen of the administration tool;

FIG. 37 shows a preferred embodiment of an edit version dialogue screen of the administration tool;

FIG. 38 shows a preferred embodiment of a main screen of the administration tool when “servers” is selected;

FIG. 39 shows a preferred embodiment of an add server dialogue screen of the administration tool;

FIG. 40 shows a preferred embodiment of a remove server dialogue screen of the administration tool;

FIG. 41A shows a preferred embodiment of a server properties dialogue screen of the administration tool;

FIG. 41B shows an alternative preferred embodiment of a server properties dialogue screen of the administration tool;

FIG. 41C shows another alternative preferred embodiment of a server properties dialogue screen of the administration tool;

FIG. 42A shows a preferred embodiment of a login properties screen of the administration tool;

FIG. 42B shows an alternative preferred embodiment of a login properties screen of the administration tool;

FIG. 43A shows a preferred embodiment of a network properties screen of the administration tool;

FIG. 43B shows an alternative preferred embodiment of a network properties screen of the administration tool;

FIG. 44A shows a preferred embodiment of a throughput properties screen of the administration tool;

FIG. 44B shows an alternative preferred embodiment of a throughput properties screen of the administration tool;

FIG. 45 shows a preferred embodiment of a graphical representation of throughput data of the administration tool;

FIGS. 46A-C are a flow diagram showing a preferred embodiment for provisioning a wireless device during a login session;

FIG. 47 is a flow diagram showing a second preferred embodiment for provisioning a wireless device during a login session; and

FIG. 48 is a flow diagram showing a preferred embodiment for facilitating application provisioning even if the wireless connection to a client device is temporarily lost during downloading.

### DETAILED DESCRIPTION OF THE PREFERRED EMBODIMENTS

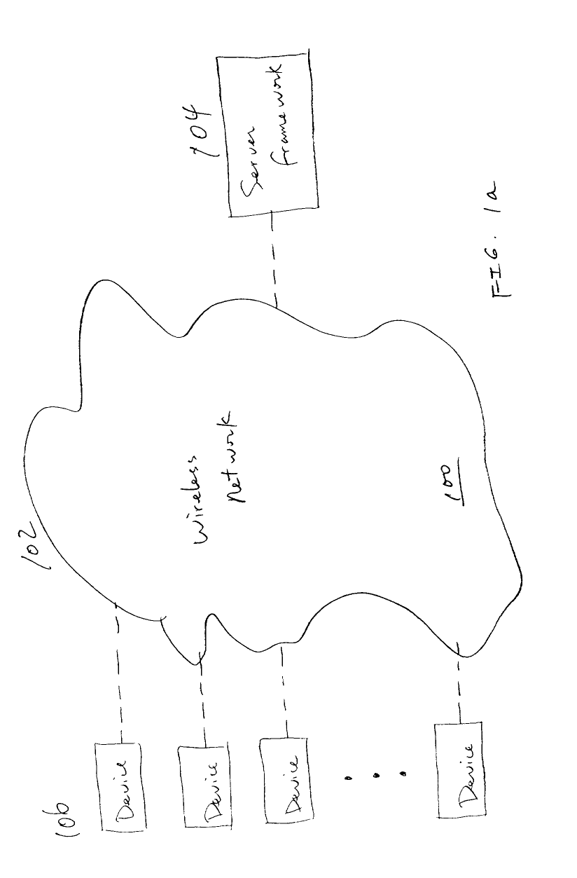

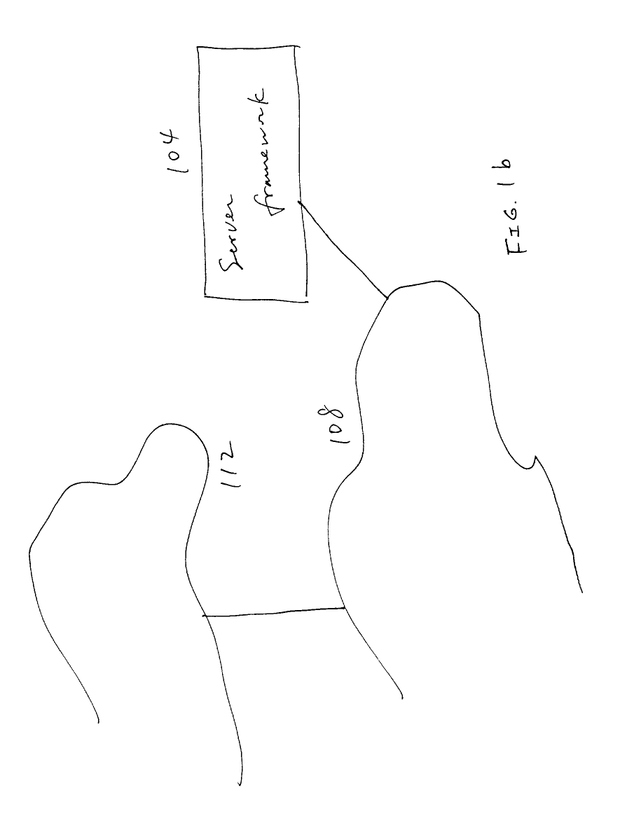

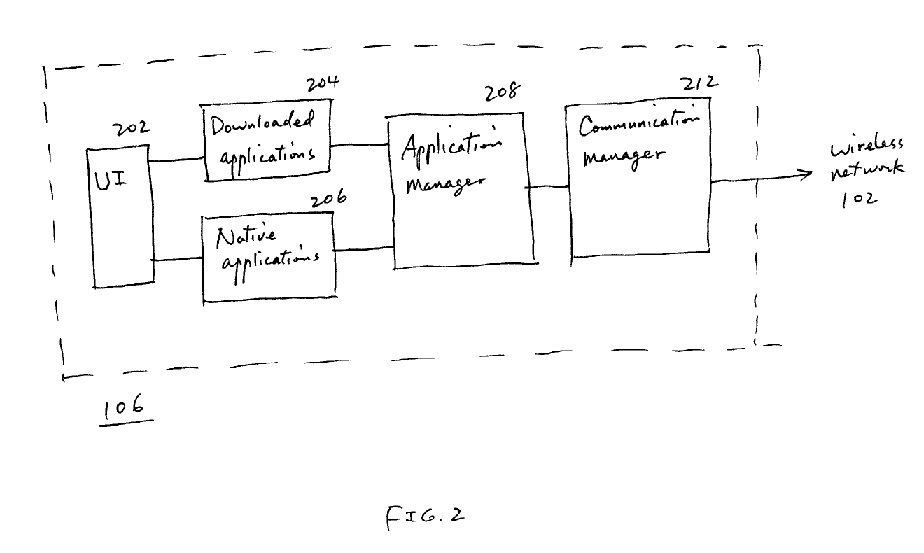

FIG. 1A is a block diagram that shows a preferred embodiment of a suitable architecture 100 for practicing the present system and method. As shown in FIG. 1A, architecture 100 preferably comprises a wireless network 102 adapted to facilitate communication between a server framework 104 and a plurality of wireless devices 106.

Although illustrated with a single network cloud, wireless network 102 may comprise one or more wireless networks including IP based networks, such as the CDPD (Cellular Digital Packet Data) network, and non-IP based networks, such as Mobitex. In addition, although server framework 104 is shown as connecting to wireless network 102 via a wireless connection, it may often be desirable for server framework 104 to connect to wireless network 102 via one or more landline networks 108 and/or the global Internet 112, as shown in FIG. 1B.

In a preferred embodiment, wireless network 102 may be configured to provide a wireless local area network (LAN) or wireless wide area network (WAN) for connecting devices 106 and server framework 104. In addition, wireless devices 106 and server framework 104 may each be provided with appropriate cryptographic capabilities to permit a wireless virtual private network (WVPN) or other secure connection to be established between them.

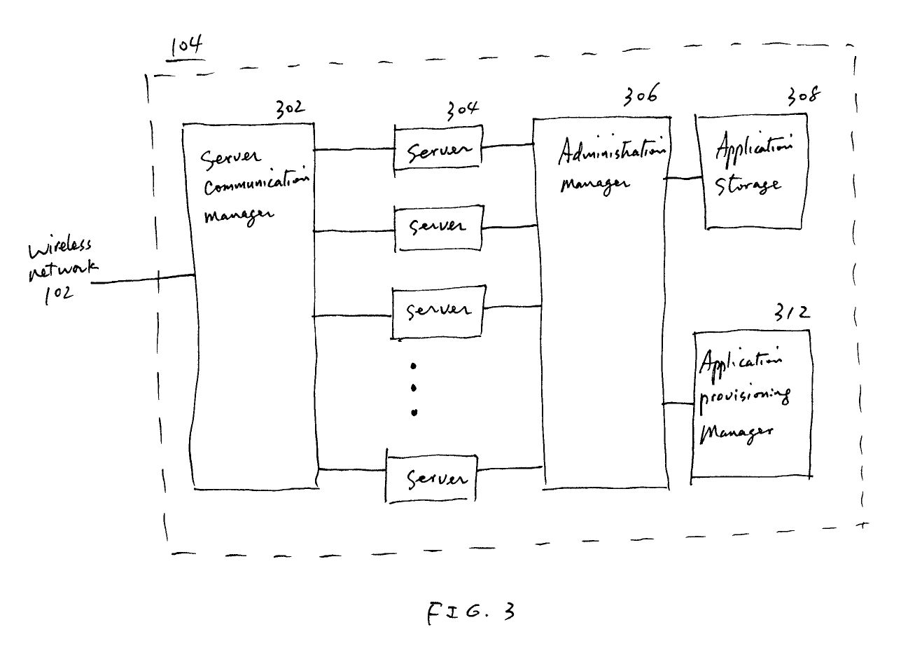

Each wireless device 106 may, for example, be a personal digital assistant (PDA) such as those manufactured by Epoc and Palm. FIG. 2 is a block diagram showing certain components of a wireless device 106 in a preferred embodiment of the present system and method.

As shown in FIG. 2, wireless device 106 preferably comprises a user interface (UI) 202, one or more downloaded applications 204, one or more native applications 206, an application manager 208, and a communication manager 212. UI 202 is adapted to present output to, and receive input from, users of device 106 and thus facilitate user interaction with downloaded applications 204 and native applications 206.

Downloaded applications 204 are applications downloaded from remote sources to device 106 via wireless network 102. In many cases, such applications are designed to communicate and cooperate with other remotely-running applications, such as applications running on server framework 104. Typical examples of such applications may include a financial spreadsheet application adapted to populate a spreadsheet with data received from a database at server framework 104.

Native applications 206 are applications residing on wireless device 106 that have not been downloaded over wireless network 102. In many cases, these applications are included with device 106 when the user purchases it. In other cases, the applications may be stored on a cartridge that is adapted to be inserted in an appropriate socket or slot of device 106. Typical examples of such applications include an address book application, a calendar application, and game applications.

Application manager 208 manages downloaded applications 204 and native applications 206 running on wireless device 106. Application manager 208 may be stored permanently on wireless device 106 or, alternatively, may be downloaded from server framework 104 each time the user initiates a communication session with server framework 104.

Communication manager 212 supports communications to and from device 106 via wireless network 102. Thus, for example, when device 106 and server framework 104 are connected by a WVPN established via wireless network 102, communication manager 212 is preferably provided with appropriate cryptographic components to permit it to encrypt and decrypt messages transmitted via the network.

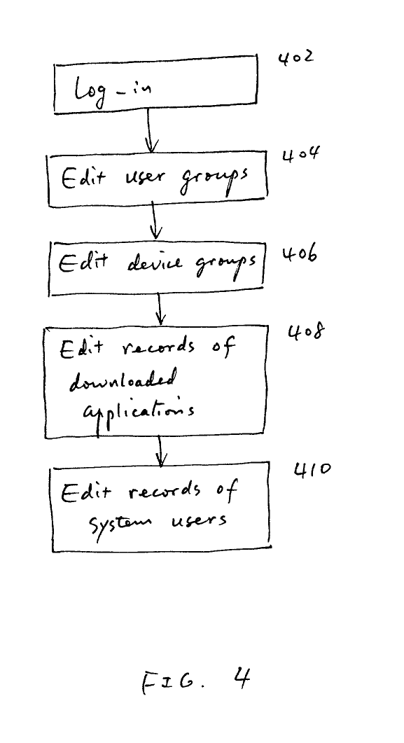

In a preferred embodiment, server framework 104 preferably comprises one or more servers running on one or more server computer systems, such as Sun Solaris systems, NT-based systems, or Linux-based systems. FIG. 3 is a block diagram showing certain components of server framework 104 in a preferred embodiment of the present system and method.

As shown in FIG. 3, server framework 104 preferably comprises a server communications manager 302, a plurality of servers 304, an administration manager 306, an application storage 308, and an application provisioning manager 312.

Server communications manager 302 supports communications to and from server framework 104 via wireless network 102. Thus, for example, when server framework 104 and devices 106 are connected by a WVPN established via wireless network 102, server communications manager 302 is preferably provided with appropriate cryptographic components to permit it to encrypt and decrypt messages transmitted via the network.

Servers 304, administration manager 306, application storage 308, and application provisioning manager 312 cooperate to manage application provisioning for devices 106. More specifically, as described in more detail below, the above components on the server side manage downloading of downloaded applications 204 to ensure that each wireless device 106 is provided with an appropriate set of downloaded applications.

Before describing operation of the present system in detail, a brief overview of that operation is first provided. Briefly, in a preferred embodiment, an administrator, acting as a superuser, sets up two different sets of permissions for each application that may be downloaded to a device 106. The first set of permissions define the users who have authority to download a particular application, and whether that download is required or optional. The second set of permissions define the types of devices 106 that are compatible with a particular application. By applying these two sets of permissions, the system is able to control application downloading so that users do not receive applications which they do not need or for which they are not authorized.

In particular, to create the first set of permissions, the administrator interacts with administration manager 306 to define and maintain categories of users and specify the applications that must or may be downloaded to users in each category. The category to which a user is assigned is typically a function of one or more factors. For example, in a corporate environment, these factors may include the corporate department within which the user works, and the user's position in that department. The administrator may also specify permission settings for an application on a system-wide or user-by-user basis, as described in more detail below.

In a preferred embodiment, for each user category and/or individual user, the administrator assigns each downloaded application 204 to one of four categories: “required,” “grant,” “unspecified,” or “deny.”

“Required” applications are applications that must be downloaded to devices 106 carried by particular users or members of particular user groups. For example, the administrator might specify that a certain balance sheet application must be downloaded to all users in the financial-department user group.

“Grant” applications are applications that may (at the user's option) be downloaded to devices 106 carried by particular users or members of particular user groups. For example, if the administrator identifies a certain spreadsheet application as “grant” for users in the financial-department user group, users belonging to this group would be permitted, but not required, to download this application to their devices 106.

“Unspecified” applications are applications for which no other permission setting is assigned with respect to a particular user or user group. The ultimate permission status for such application and, thus, the determination as to whether such applications must, may, or may not be downloaded to a particular user, are typically controlled by a permission setting established for a different user group to which the user belongs, as described in more detail below.

“Deny” applications are applications that are not permitted for a particular user or members of particular user groups. For example, continuing with the example from above, if the administrator identifies the spreadsheet application as “unauthorized” for users in the engineering user group, users belonging to that group would not be permitted to download the application.

In a preferred embodiment, the system comprises a user group called “all users” that includes all system users. By assigning a “required” status to an application for this group, the administrator makes the application “system required,” i.e., required for all system users. For example, the administrator might specify that a certain virus detection application is required for the “all users” group and therefore required for all system users.

To create the second set of permissions, the administrator defines one or more device types and specifies applications that are compatible with each device type. For example, the administrator might specify that a particular spreadsheet application is compatible with a Palm PDA but not a Compaq PDA.

When a user logs on to server framework 104, the system determines what downloaded applications 204 are resident on the user's device and automatically downloads to the user any “required” applications that the user does not have that are compatible with the user's device. In addition, the system provides the user the option to download any “grant” applications. Finally, the system deletes from the user's device any “unauthorized” applications. In this way, the system ensures that the user has an appropriate set of applications on his or her device 106.

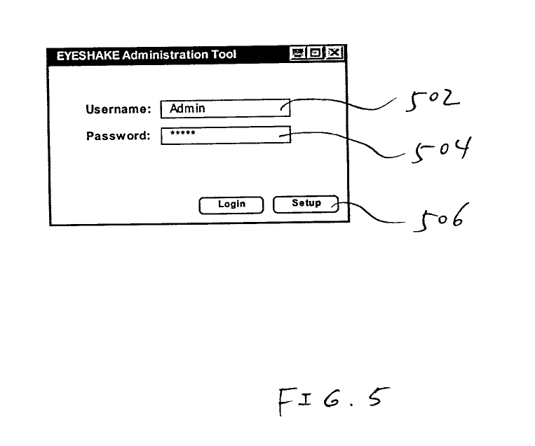

FIG. 4 is a flow diagram showing a process by which an administrator may establish and maintain user and device categories and set permission values for applications for each category. Although the steps in FIG. 4 are shown in a particular order, it will be recognized that this order is merely illustrative and that the administrator may perform these steps in other orders if desired using the administration tool described below.

Turning to FIG. 4, at step 402, the administrator logs into an administrator account of the administration tool by entering an appropriate username and password. At step 404, the administrator creates or edits records for one or more user groups. As described in more detail below, the administrator may specify the composition of each user group as well as setting group-specific permission settings for particular applications that determine the applications that users in the group must, may, or may not have downloaded to their devices 106.

At step 406, the administrator creates or edits records for one or more device types. As described in more detail below, the administrator may specify a name and description for each device type and assign device-specific permission settings that determine whether a particular application may be downloaded to a particular device type.

At step 408, the administrator creates or edits records for one or more downloaded applications 204. As described in more detail below, the administrator may specify a name and description for each application and set permission settings that define the device types to which the application may be downloaded.

At step 410, the administrator creates or edits records for one or more system users. As described in more detail below, the administrator may specify a username and description for each user as well as set the user categories to which the user belongs and choose user-specific permission settings for each application that determine the applications that the user must, may, or may not have downloaded to his or her device 106.

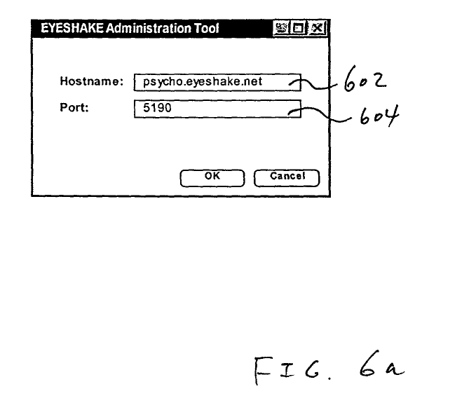

A preferred embodiment of an administration tool for creating and editing user, user category, device type, and application records is now described in connection with FIGS. 5-45.

FIG. 5 shows a preferred embodiment of a login screen for the administration tool. As shown in FIG. 5, the login screen preferably comprises a username field 502 and a password field 504 to permit the administrator to log into the administration tool.

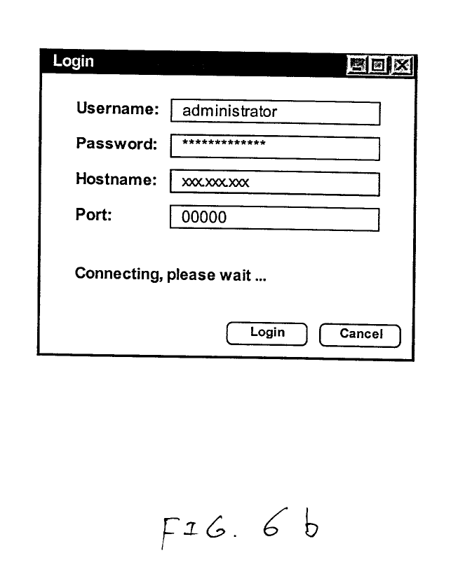

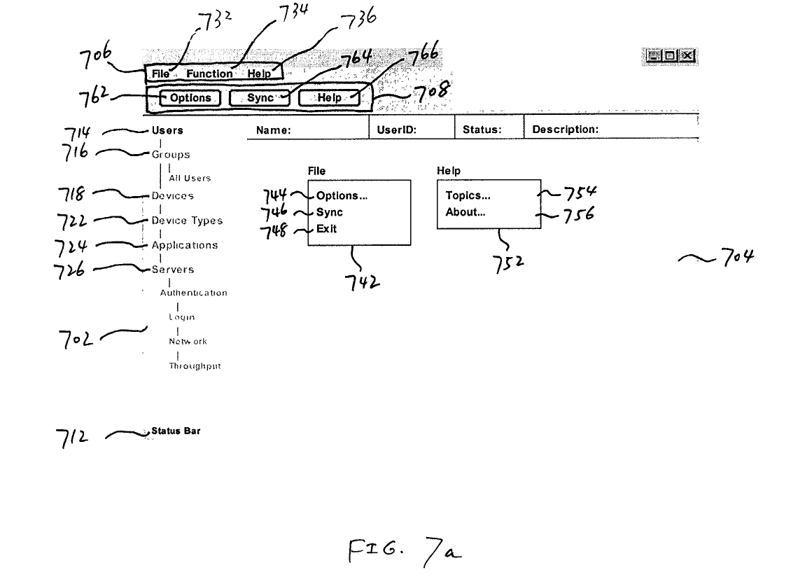

Selecting setup button 506 in FIG. 5 preferably takes the administrator to a setup screen where he or she may set or edit the hostname and port number for the administration-tool server. A preferred embodiment of the setup screen is shown in FIG. 6A. Hostname field 602 preferably holds the IP address of the administration-tool server. Port field 604 preferably holds the correct port number for the authentication server. In an alternative preferred embodiment, the contents of FIGS. 5 and 6A may be combined in one screen, as shown in FIG. 6B.

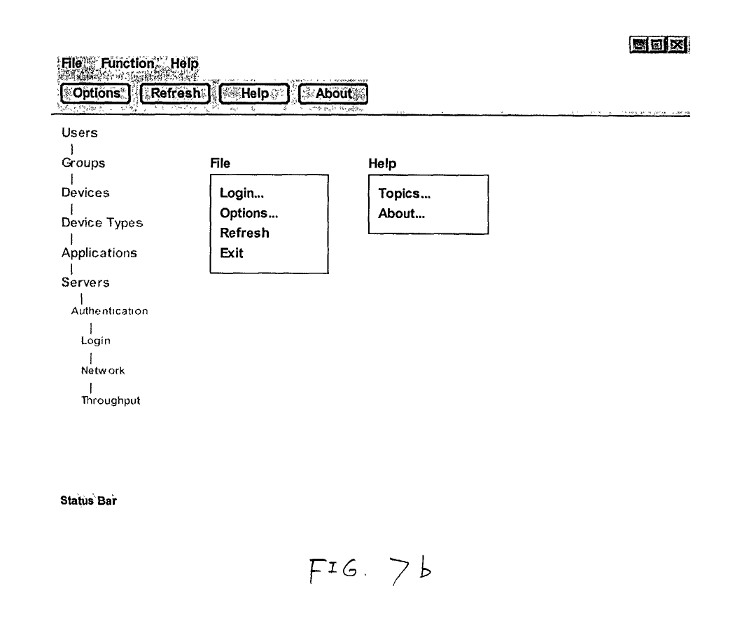

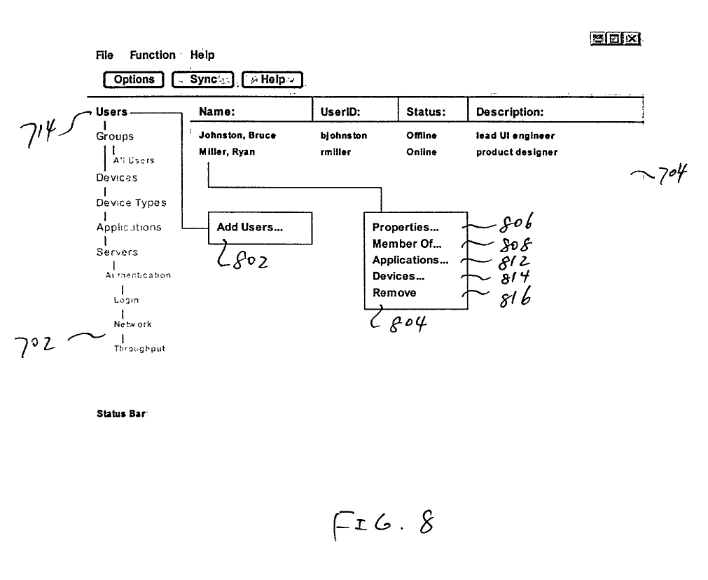

FIG. 7A shows a preferred embodiment of a main screen which is displayed after the administrator successfully logs in. As shown in FIG. 7A, the main screen preferably contains an expandable tree structure 702, a panel 704, a menu bar 706, a tool bar 708, and a status bar 712.

Expandable tree structure 702 preferably comprises six main categories: users 714, groups 716, devices 718, device types 722, applications 724, and servers 726. Selection of a category in expandable tree structure 702 preferably causes display of data associated with the category in panel 704, as described in more detail below.

FIG. 7B shows an alternative preferred embodiment of the main screen shown in FIG. 7A. In this embodiment, the administrator may access the main screen without first viewing the login screen of FIG. 5. As shown in FIG. 7B, there is a “login” option for the administrator to log in. This option, if invoked, will activate the login screen of FIG. 5.

In FIG. 7B, selecting the “refresh” option from the tool bar or from the pull-down menu of “file” will prompt the administration tool to check for any changes made to users, groups, devices, device types, and servers, and visually reflect any such changes.

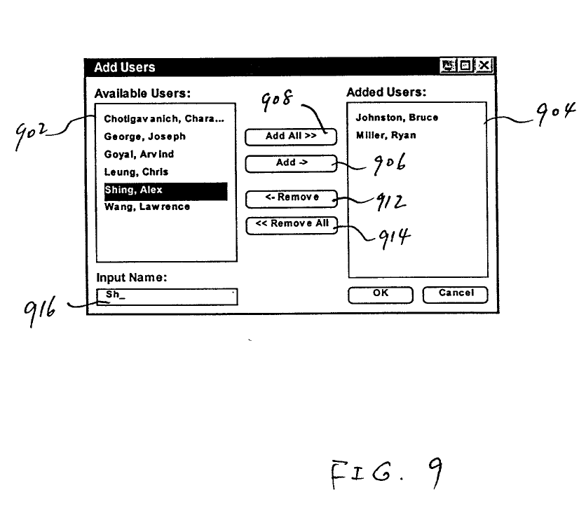

FIG. 8 shows a preferred embodiment of the main screen when users 714 in expandable tree structure 702 is selected. As shown in FIG. 8, when users 714 is selected, panel 704 preferably comprises a table that displays for each user: (1) the user's name, (2) the user's ID, (3) the user's status, i.e., whether or not the user is currently logged onto the system, and (4) a description of the user, e.g., the user's job description.

In FIG. 8, right clicking users 714 preferably opens a menu comprising an add users item 802. Selecting add users 804 preferably causes an add users screen to be displayed that may be used by the administrator to add users to the system.

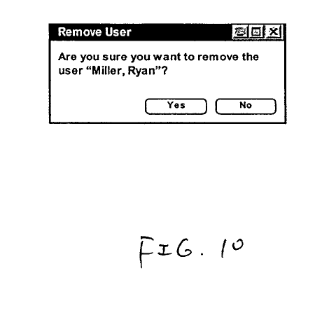

FIG. 9 shows a preferred embodiment of an add users screen. The screen preferably permits the administrator to import users from various systems. As shown in FIG. 9, the add user screen preferably comprises an available users window 902 that lists users who may be added to the system. This list preferably contains all users from the system that the administration tool is adding from, with the exception of those users that are displayed in added user window 904 or that have previously been added. The administrator may move users to added users window 902 by selecting one or more available users and clicking add button 906, or by clicking add all button 908. In a similar manner, users in added users window 904 may be returned to available users window 902 using remove button 912 or remove all button 914.

Input name field 916 allows the administrator quick access to an alphabetically matched listing within the available users window 902. As the administrator types characters into the field, the list above automatically scrolls to and selects the entry that most closely matches the text string.

Returning to FIG. 8, selection of one or more users in panel 704 preferably opens a menu that includes the following options: properties 806, member of 808, applications 812, devices 814, and remove 816.

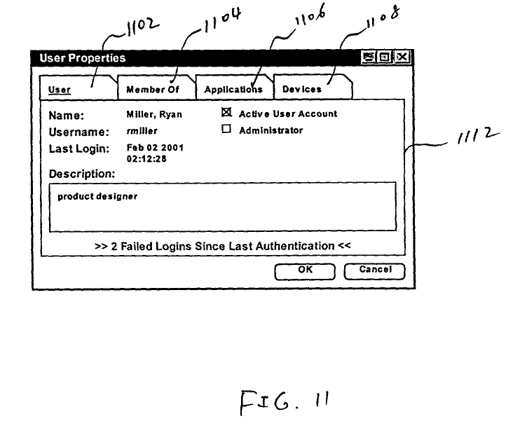

Selecting remove 816 removes the one or more selected users from the system. In a preferred embodiment, the system may prompt the administrator with a separate confirmation dialog to confirm removal of each selected user, such as shown in FIG. 10. When multiple users have been selected for removal, the confirmation dialog of FIG. 10 may also be provided with a yes to all button to permit the administrator to confirm removal of all users without being shown a confirmation dialog for each.

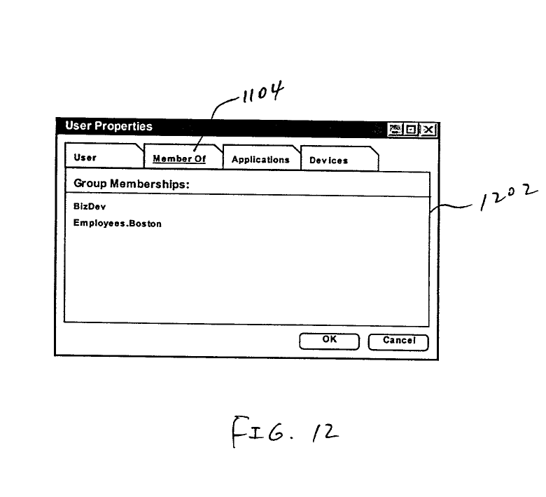

Returning to FIG. 8, selecting properties 806, member of 808, applications 812, or devices 814 preferably opens a tabbed user properties dialog. FIG. 11 shows a preferred embodiment of the user properties dialog. As shown in FIG. 11, the user properties dialog preferably comprises four tabs: user 1102, member of 1104, applications 1106, and devices 1108. The dialog may contain more tabs (not shown), including a downloads tab. When a tab is selected, a panel 1112 of the dialog preferably displays information associated with the selected tab.

In a preferred embodiment, the user tab in FIG. 11 is automatically selected when the administrator selects properties 806 in FIG. 8, the member of tab in FIG. 11 is automatically selected when the administrator selects member of 808 in FIG. 8, the applications tab in FIG. 11 is automatically selected when the administrator selects applications 812 in FIG. 8, and the devices tab in FIG. 11 is automatically selected when the administrator selects devices 814 in FIG. 8.

As will be recognized, FIG. 1 shows a preferred embodiment of the user properties dialog when the user tab 1102 is selected. As shown in FIG. 11, panel 1112 preferably displays information concerning the user including his or her name, username, last login, description, whether the user's account is active, and whether the user has administrator rights. In a preferred embodiment, each user's account is initially designated “active.” However, an administrator may change that status to “disabled” to temporarily block login access to a particular user. The system may also automatically change this setting to “disabled” if the administrator sets up a system option of blocking access after a number of successive failed login attempts.

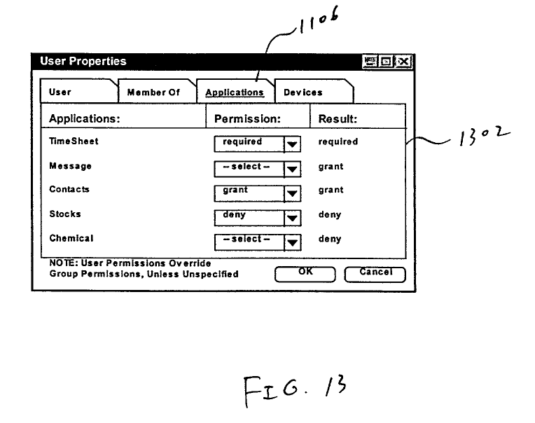

FIG. 12 shows a preferred embodiment of the user properties dialog when the member of tab 1104 is selected. As shown in FIG. 12, panel 1202 preferably displays the user groups to which the user belongs.

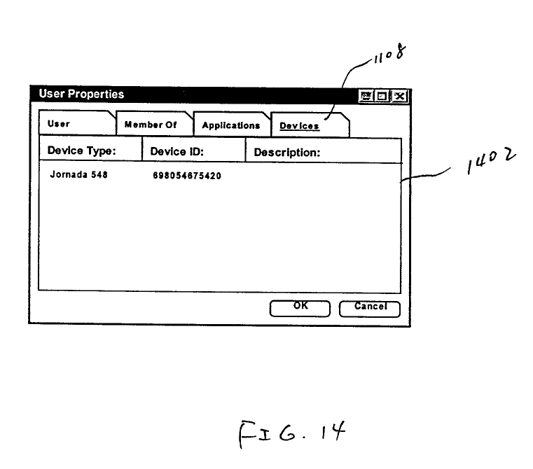

FIG. 13 shows a preferred embodiment of the user properties dialog when the applications tab 1106 is selected. This is the user application permissions screen and preferably contains a table 1302 which allows the administrator to set software download permissions for the selected user.

As shown in FIG. 13, table 1302 preferably displays, for each downloadable application: (1) the application's name, (2) a permission setting for the application, and (3) a permission status for the application. The permission setting is preferably implemented as a pull down menu that allows the administrator to select a desired permission setting for the application (required download, grant download, deny download, or unspecified). The permission status column (labeled “Result” in FIG. 13) specifies the actual permission status for the application for this user based on both the permission setting for the specific user, as well as settings for user groups to which the user belongs. In a preferred embodiment, permission settings established for a particular user typically dominate those established for a user group to which the user belongs, as described in more detail below.

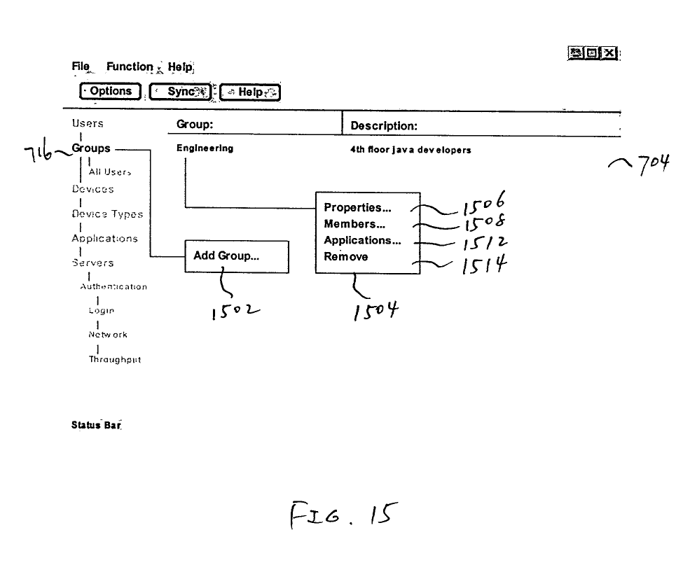

FIG. 14 shows a preferred embodiment of the user properties dialog when the devices tab 1108 is selected. As shown in FIG. 14, table 1402 preferably displays information concerning each device carried by the user including device type and device ID, as described in more detail below.

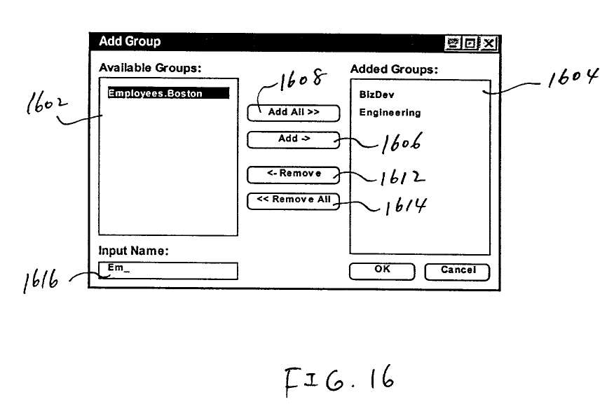

FIG. 15 shows a preferred embodiment of a screen that may be used by an administrator to manage one or more user groups. It is preferably displayed when groups 716 in FIG. 7a is highlighted. As shown in FIG. 15, this screen preferably comprises a table that lists the name and a description for each user group in the system.

A right-click on group 716 preferably opens a menu comprising an add group item 1502. Selection of add group item 1502 preferably displays an add groups screen to the administrator.

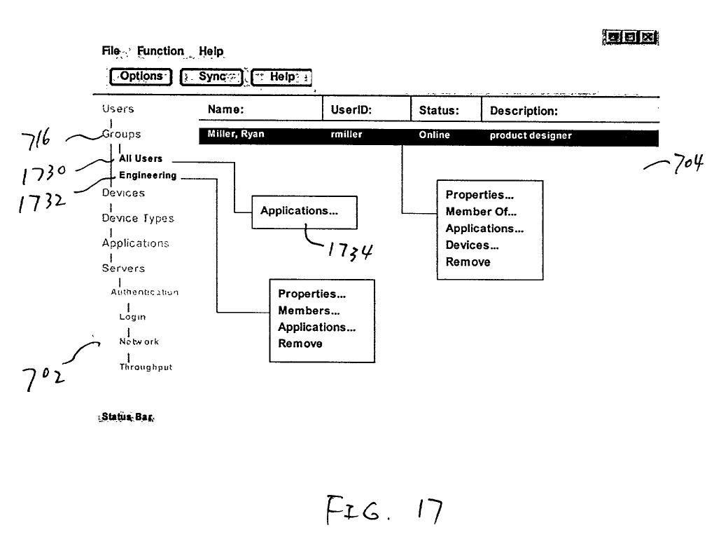

FIG. 16 shows a preferred embodiment of an add groups screen that permits the administrator to import groups from various systems. As shown in FIG. 16, the add groups screen preferably comprises an available groups window 1602 that lists groups that may be added to the system. The administrator may move groups to added groups window 1604 by selecting one or more available groups from an available groups window 1602 and selecting add button 1606, or by selecting add all button 1608. In a similar manner, groups in added groups window 1604 may be returned to available groups window 1602 using remove button 1612 or remove all button 1614.

Input name field 1616 allows the administrator quick access to an alphabetically matched listing within available groups window 1602. As the administrator types characters into the field, the list above automatically scrolls to and selects the entry that most closely matches the text string.

Returning to FIG. 15, selecting a group in panel 704 preferably opens a menu 1504 that contains the following options: properties 1506, applications 1508, members 1512, and remove 1514.

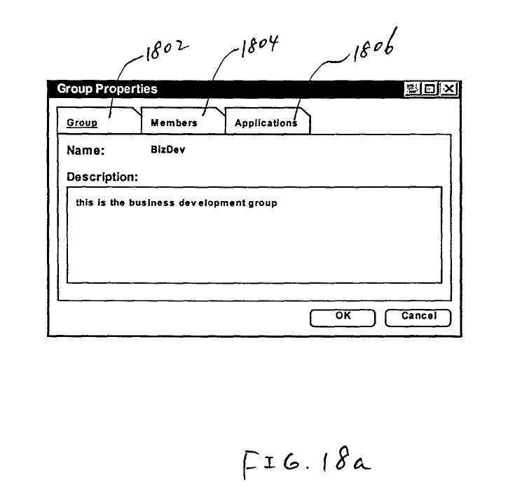

As shown in FIG. 17, groups 716 may preferably be expanded to show all known groups as children in tree 702. Selecting a child in the tree preferably causes display of its members in panel 704. Selecting a user name, such as engineering 1732, in panel 704 in FIG. 17 preferably causes a similar result to selecting a user name in panel 704 in FIG. 8.

One of the groups shown in FIG. 17 is all users 1730. This is a special type of group that preferably always appears as a child in the tree and cannot be removed from the system.

As users are added to the system, they automatically become members of this group. One reason for its existence is to allow administrators a way to easily provide all users with access to various pieces of information. As a result, a panel 1734 associated with this group preferably only has single option: “applications.” By selecting this option and assigning a permission setting of “required” to an application, the administrator can effectively make an application “system required,” i.e., required for all system users.

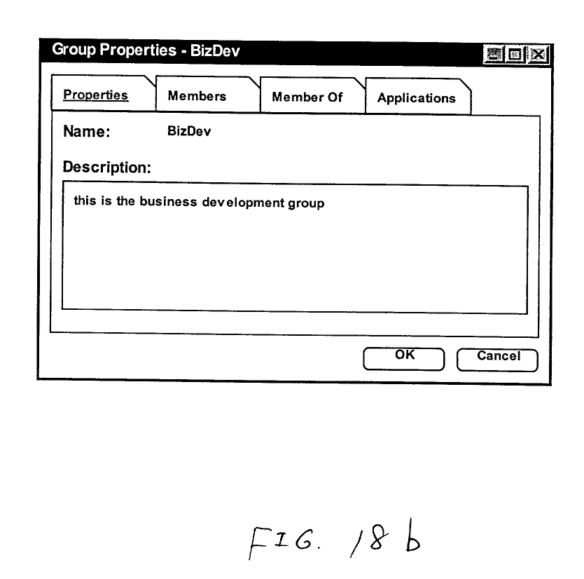

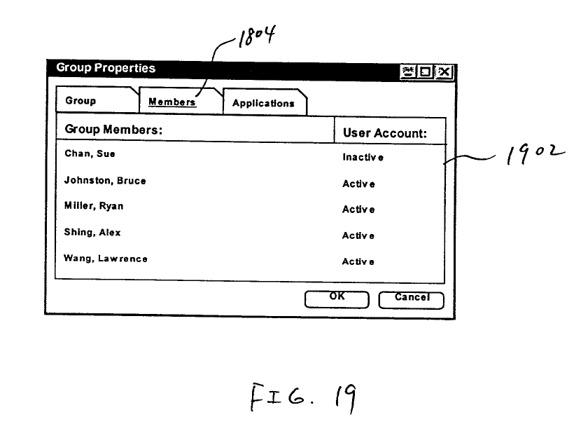

FIG. 18A shows a preferred embodiment of a properties dialog screen that is displayed by selecting properties 1506 in menu 1504 in FIG. 15. It is preferably a tabbed dialog screen that includes the following tabs: group 1802, members 1804, and applications 1806. In a preferred embodiment, selecting properties 1506, members 1508, or applications 1512 in FIG. 15 has the same effect as selecting group 1802, members 1804, or applications 1806, respectively, in FIG. 18A. In an alternative preferred embodiment, the dialog screen contains an additional tab “member of” as shown in FIG. 18B.

As will be recognized, FIG. 18A shows the case when the tab for group 1802 is selected. This screen preferably displays information concerning the selected group including its name and description.

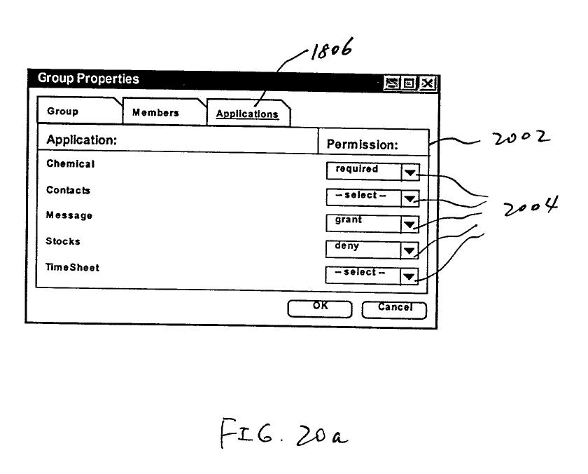

FIG. 19 shows a preferred embodiment of the group properties screen displayed when the tab for members 1804 is selected. This screen preferably comprises a table 1902 that lists all members in the selected group and identifies whether each member's status is active or inactive.

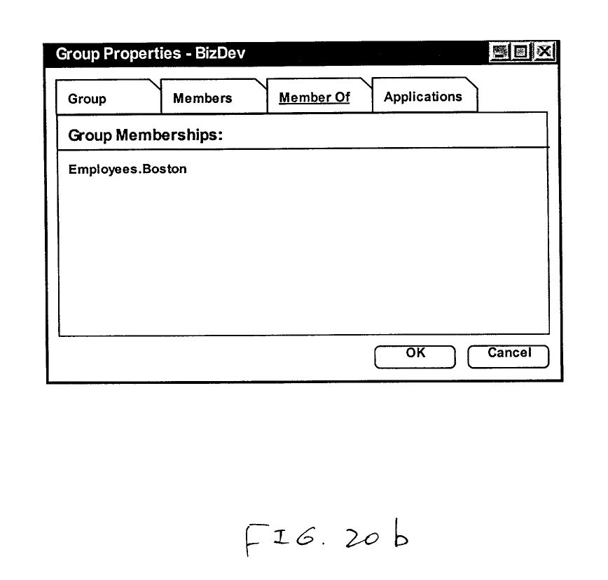

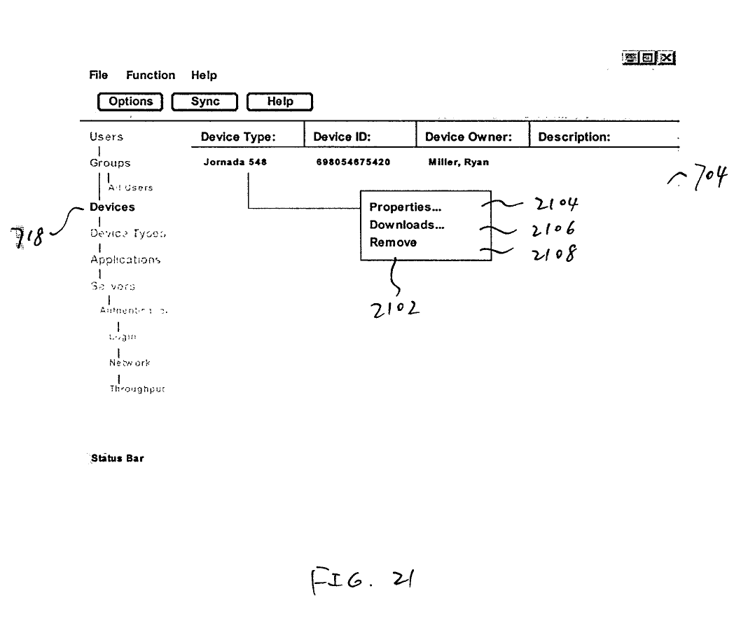

FIG. 20A shows a preferred embodiment of the group properties screen displayed when the tab for applications 1806 is selected. This screen is used by the administrator to set application download permissions for the selected group. The screen preferably comprises a table 2002 that lists all applications available for download and the permission status for each application. In a preferred embodiment, the administrator may select the permission status from a pulldown menu 2004 that displays the possible permission settings.

FIG. 20B shows a preferred embodiment of the group properties screen displayed when the additional tab “member of” is selected from the alternative preferred embodiment shown in FIG. 18B.

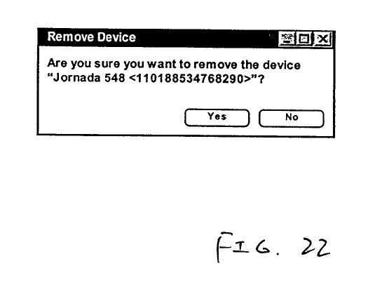

FIG. 21 shows a preferred embodiment of a screen for managing wireless devices 106 that is displayed when devices 718 of the main screen shown in FIG. 7A is highlighted. In a preferred embodiment, panel 704 preferably comprises a table that lists each individual device that may connect to server framework 104 and identifies the ID number and owner for each listed device. The table in panel 704 may also include a column for displaying a description of each listed device.

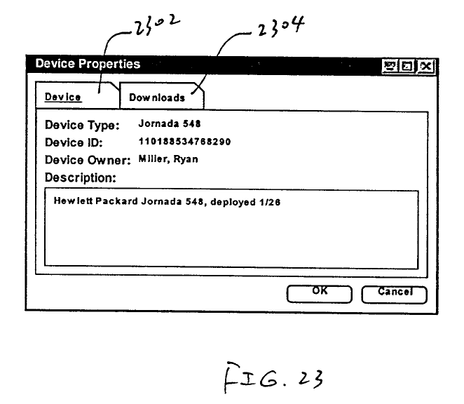

Selecting one or more devices in the table in panel 704 preferably opens a menu 2102 with the following options: properties 2104, downloads 2106, and remove 2108. Selecting remove 2108 removes the one or more selected devices from the system. In a preferred embodiment, the system may prompt the administrator with a separate confirmation dialog to confirm removal of each selected device, such as with the dialog shown in FIG. 22. When multiple devices are selected for removal, the confirmation dialog of FIG. 22 may also include a yes to all button to permit the administrator to confirm removal of all devices without being shown a confirmation dialog for each.

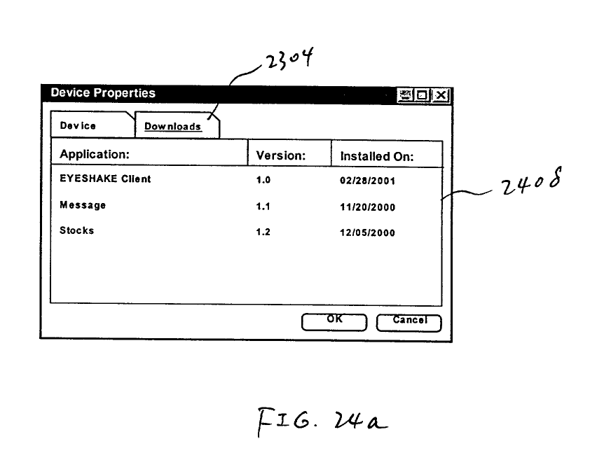

Returning to FIG. 21, selecting properties 2104 or downloads 2106 causes display of a device properties dialog that is preferably implemented as a tabbed dialog. FIG. 23 shows a preferred embodiment of the device properties dialog when properties 2104 in FIG. 21 or the tab for device 2302 in FIG. 23 is selected. As shown in FIG. 23, this screen preferably displays information concerning the selected device including the device type, device ID, device owner, and a description of the device.

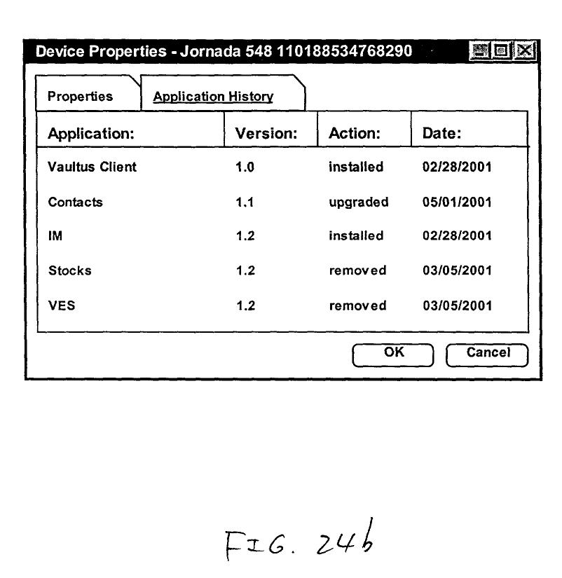

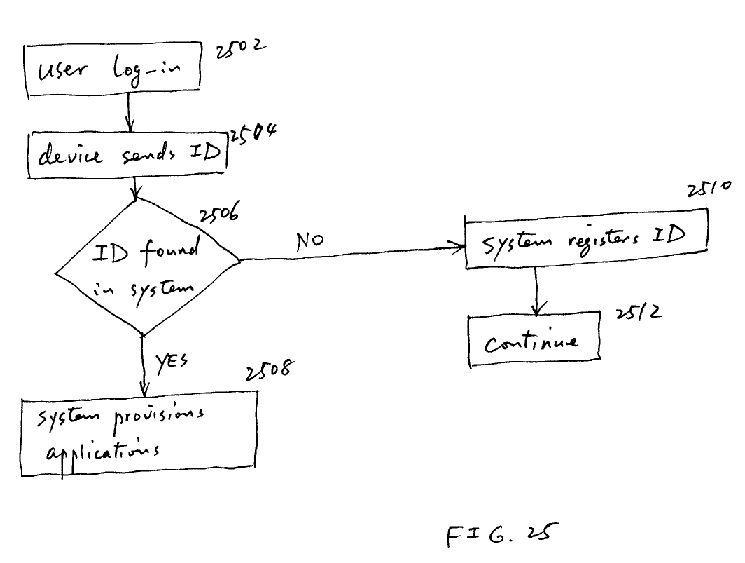

FIG. 24A shows a preferred embodiment of the device properties dialog when downloads 2106 in FIG. 21 or the tab for downloads 2304 in FIG. 23 is selected. As shown in FIG. 24A, this screen preferably comprises a table 2408 that displays a list of downloaded applications that are currently resident on a specified device, the version number for each listed downloaded application, and the date the application was last downloaded to the device. In an alternative preferred embodiment, this dialog may appear as shown in FIG. 24B.

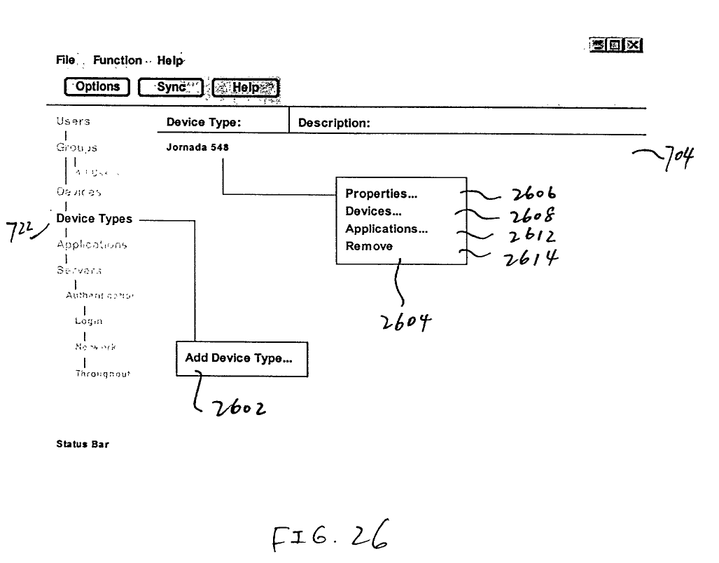

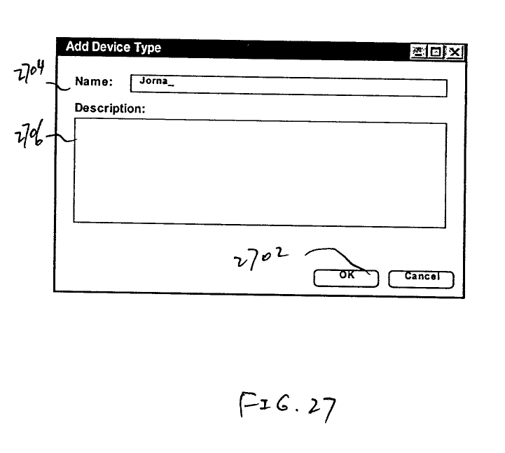

In a preferred embodiment, the administrator does not add devices to the system. Devices are added by the users themselves when they first log in. A preferred embodiment for adding devices to the system is now described in connection with FIG. 25. As shown in FIG. 25, at step 2502, a user logs into the system. At step 2504, the device sends its device type and unique device ID to a system server, preferably the authentication server. At step 2506, the authentication server compares the received device ID with the list of device IDs corresponding to devices currently registered with the system. If the ID is found in the system, processing proceeds to step 2508 where the system provisions device 106 with an appropriate set of downloaded applications, as described in more detail below. Otherwise, if the ID is not found, processing proceeds to step 2510 where a record is created for the device. Processing then continues with step 2512.

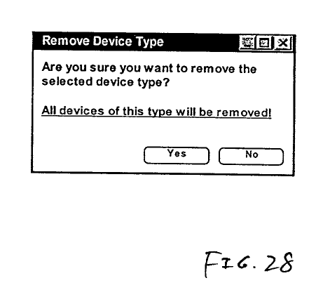

FIG. 26 shows a preferred embodiment of a screen for managing device types that is displayed when device types 722 is highlighted in FIG. 7A. As shown in FIG. 26, panel 704 preferably comprises a table that displays a list of all device type recognized by the system and a description of each listed device type.

Right clicking on device types 722 preferably opens a menu that includes an add device type item 2602. Selecting item 2602 preferably causes display of an add device type dialog.

FIG. 27 shows a preferred embodiment of an add device type dialog screen. As shown in FIG. 27, this screen preferably includes fields used by the administrator to enter a device type name 2704 and description 2706 for the new device type. Selecting OK button 2702 causes a record for the new device type to be established.

Returning to FIG. 26, selecting one or more device types listed in panel 704 preferably opens a menu 2604 which includes the following items: properties 2606, devices 2608, applications 2612, and remove 2614. Selecting remove 2614 removes the one or more selected device types from the system. In a preferred embodiment, the system may prompt the administrator with a separate confirmation dialog to confirm removal of each selected device type, such as with the dialog shown in FIG. 28. When multiple device types are selected for removal, the confirmation dialog of FIG. 28 may also include a yes to all button to permit the administrator to confirm removal of all selected device types without being shown a confirmation dialog for each.

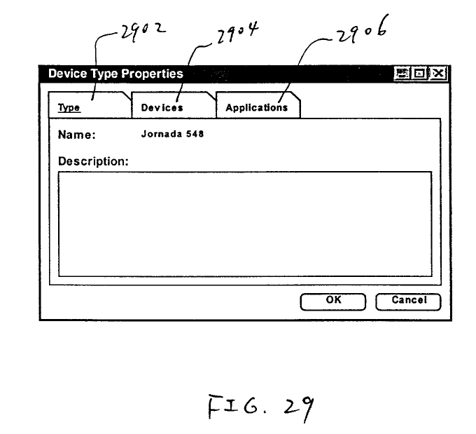

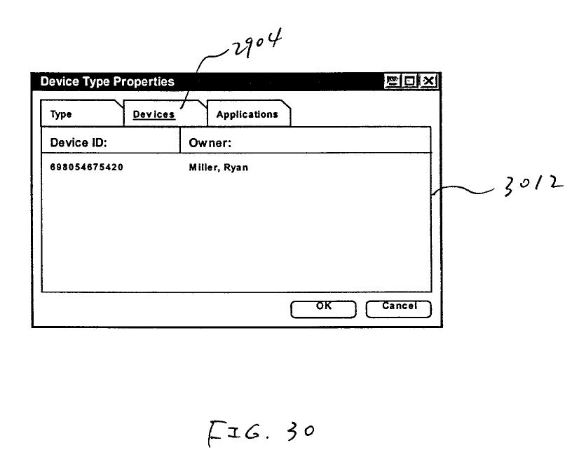

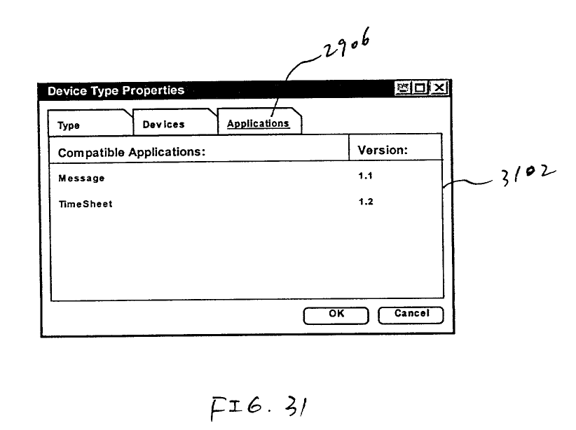

In FIG. 26, selecting properties 2606, devices 2608, or applications 2612 preferably causes display of a tabbed device type properties dialog. FIG. 29 shows a preferred embodiment of the device type properties dialog that is displayed when properties 2606 in FIG. 26 or the type tab 2902 in FIG. 29 is selected. As shown in FIG. 29, this screen preferably displays the name and a description of the selected device type.

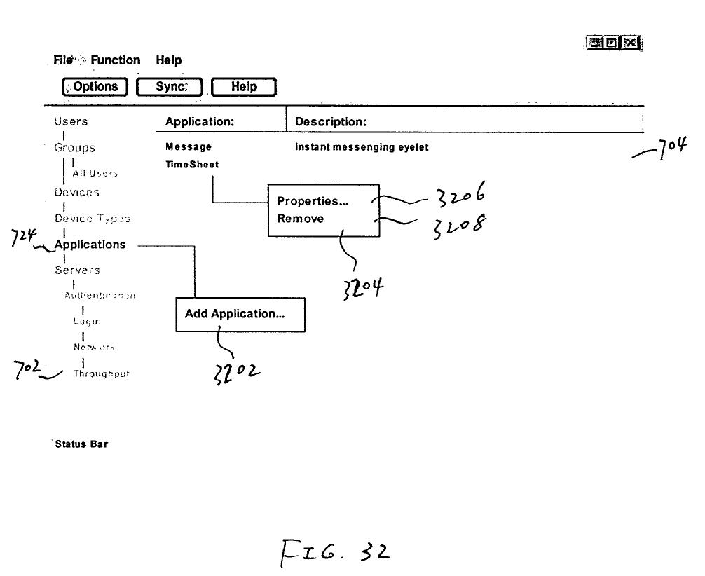

FIG. 30 shows a preferred embodiment of the device properties dialog screen that is displayed when devices 2608 in FIG. 26 or the devices tab 2904 in FIG. 29 is selected. As shown in FIG. 30, this screen preferably comprises a table 3012 that displays the device ID and owner of each device in the device type.

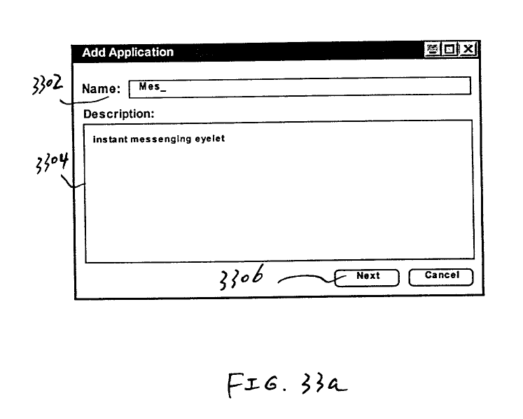

FIG. 31 shows a preferred embodiment of the device properties dialog screen when applications 2612 in FIG. 26 or the applications tab 2906 in FIG. 29 is selected. As shown in FIG. 31, this screen preferably comprises a table 3102 that lists all applications (including version numbers) that are compatible with the selected device type. The administrator may use this screen to monitor and edit the list of applications specified as compatible with the selected device type.

Because different devices may possess different operating systems, Java virtual machines, or form factors, application developers often opt to create different versions of an application for different device types. Administrators therefore preferably specify a particular version or versions of each application that is or are compatible with each device type.

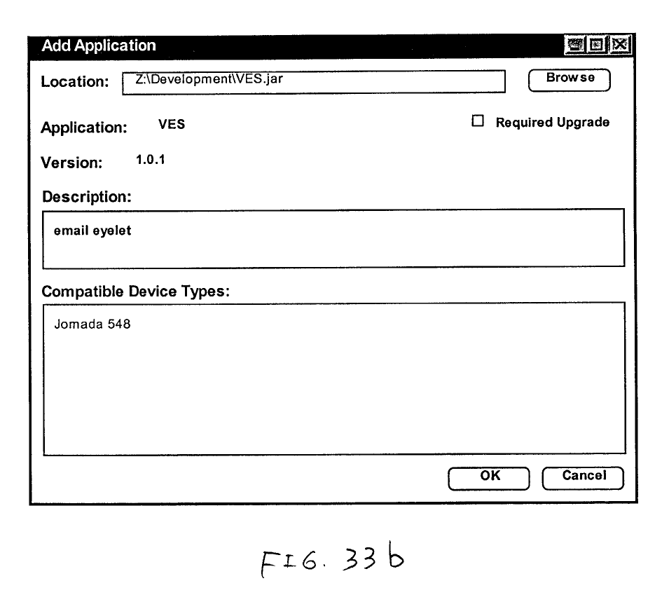

FIG. 32 shows a preferred embodiment of a screen for managing applications that is displayed when applications 724 is highlighted in FIG. 7a As shown in FIG. 32, panel 704 preferably comprises a table that lists all downloadable applications and a corresponding description for each listed application.

Right clicking applications 724 preferably opens a menu that includes an add application item 3202. Selecting this item preferably causes a an add application dialog to be displayed.

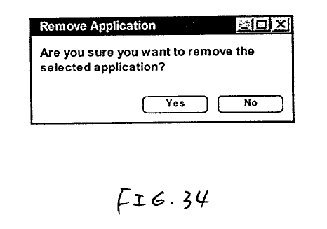

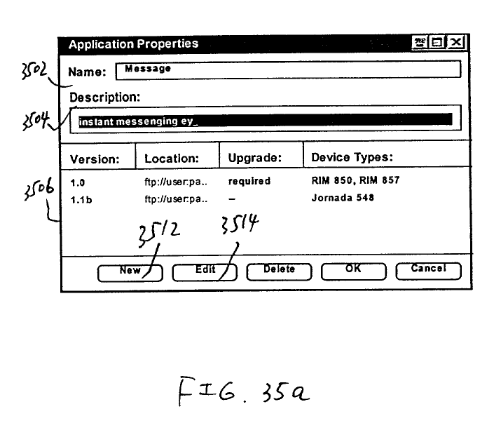

FIG. 33A shows a preferred embodiment of an add application dialog. As shown in FIG. 33A, this dialog preferably includes fields used by the administrator to enter a name 3302 and description 3304 for the new application. Selecting next button 3306 in FIG. 33A takes the administrator to another screen (not shown) where additional applications may be added.

FIG. 33B shows an alternative preferred embodiment of an add application dialog. As shown in FIG. 33B, this dialog preferably includes a “location” field showing the path of the application file for the selected application. After specifying the location of an application file, the name and version of the application will automatically appear in an “application” and a “version” field, respectively. This dialog preferably also includes a “browse” icon which, if clicked, will bring up a dialog screen from which the administrator can browse the network and specify an application file, a “required upgrade” checkbox which notifies all existing client users of the need to upgrade from their existing version of the application, a “description” field displaying information to be stored relating to the application, and a “compatible device types” list which displays all compatible client devices for the selected application.

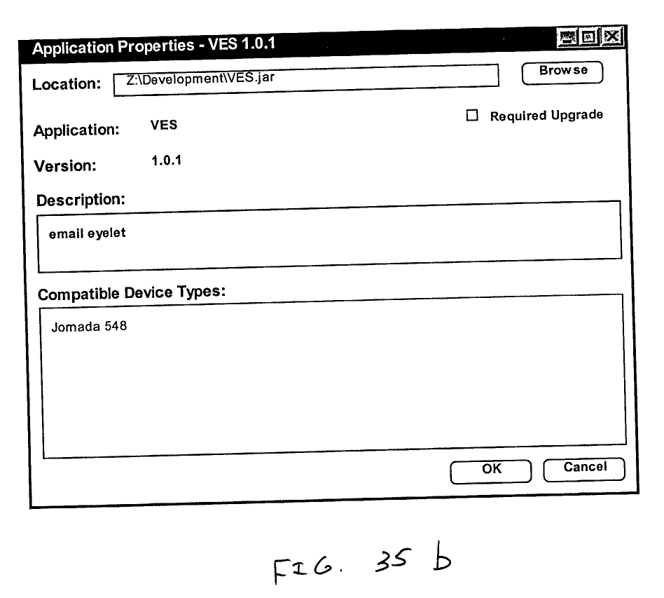

Returning to FIG. 32, selecting a particular application in panel 704 preferably opens a menu 3204 which includes the following items: properties 3206 and remove 3208. Selecting remove 3208 removes the selected application from the system. In a preferred embodiment, the system may prompt the administrator with a separate confirmation dialog to confirm removal of each selected application, such as with the dialog shown in FIG. 34. When multiple applications are selected for removal, the confirmation dialog of FIG. 34 may also include a yes to all button to permit the administrator to confirm removal of all selected applications without being shown a confirmation dialog for each.

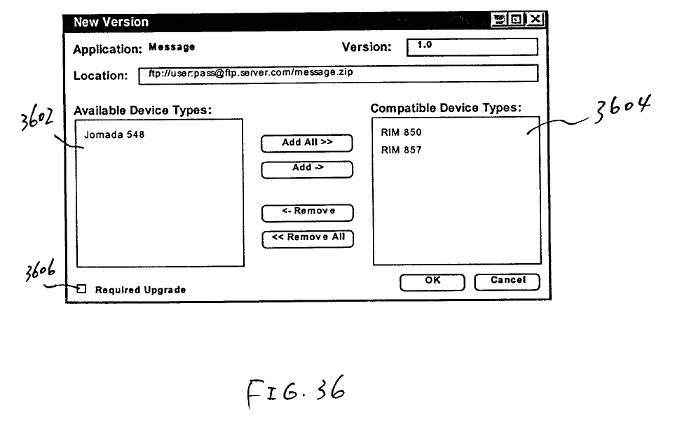

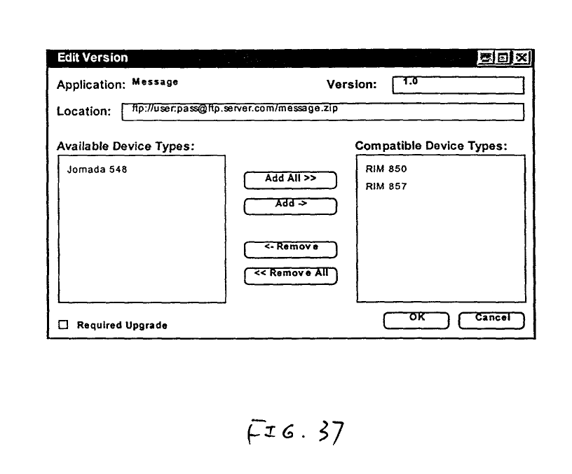

Returning to FIG. 32, selecting properties 3206 preferably causes display of an applications properties screen that permits the administrator to view and edit information concerning a selected application. A preferred embodiment of an applications properties screen is shown in FIG. 35A. As shown in FIG. 35A, the application properties screen preferably displays the name 3502 and description 3504 of the selected application. The screen also preferably comprises a table 3506 that comprises a list of one or more versions of the applications and, for each listed version, the location where the version is stored, an indication as to whether an upgrade for the version is available and/or required, and a list of device types that are compatible with the version. An alternative preferred embodiment of the applications properties screen is shown in FIG. 35B.

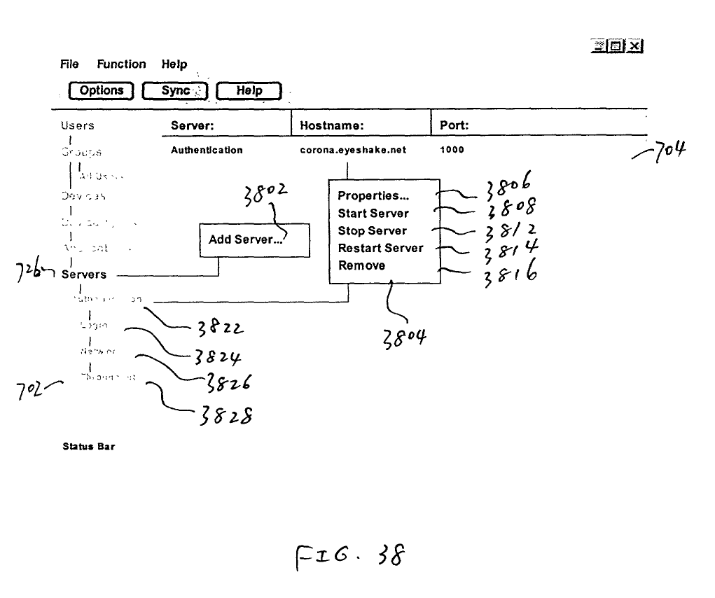

In the preferred embodiment shown in FIG. 35A, selecting new button 3512 causes display of a new application version screen that allows the administrator to add a new row to table 3506. FIG. 36 shows a preferred embodiment of this screen. As shown in FIG. 36, the screen preferably comprises editable fields for the administrator to enter a version number and a location from which the application version may be retrieved. In addition, the screen preferably allows the administrator to define device types that are compatible with the new version by moving device types to or from a compatible device types list 3602 to an available device types list 3604. Selecting the required upgrade checkbox 3606 in FIG. 36 makes the new version a required upgrade for all devices that currently have earlier versions of the application installed.

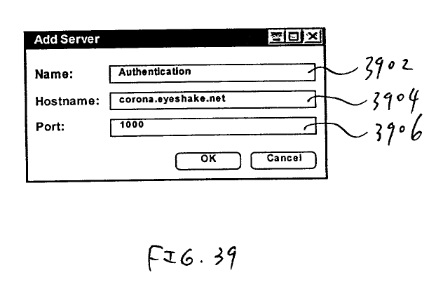

Returning to FIG. 35A, selecting edit button 3514 causes display of an edit version screen that allows the administrator to edit information concerning an existing row in table 3506. FIG. 37 shows a preferred embodiment of this screen. The screen is preferably automatically populated with the current information for the selected version in FIG. 35A. The administrator may then modify the displayed information and save the changes by clicking the OK button.

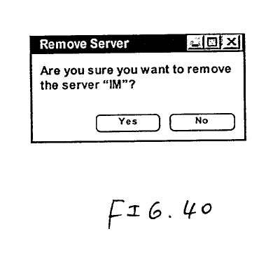

FIG. 38 shows a preferred embodiment of a screen for managing servers 304 that is displayed when servers 726 is highlighted in FIG. 7A. This screen, and the screens that follow, permit an administrator to view important statistics about, and identify problems with, each server 304. As shown in FIG. 38, panel 704 preferably comprises a table that lists a name and hostname for each server, and the port to which each listed server is connected.

Selecting servers 726 opens a menu that includes an add server item 3802. Selecting add server item 3802 takes the administrator to an add server screen, where a new server can be added.

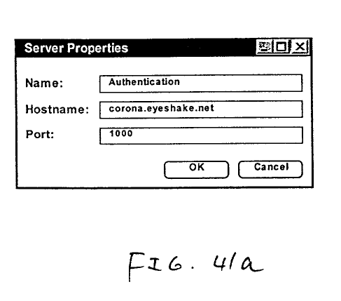

FIG. 39 shows a preferred embodiment of an add server screen. As shown in FIG. 39, it preferably comprises editable fields that permit the administrator to enter a name 3902, hostname 3904, and port 3906 for the server to be added.

Returning to FIG. 38, selecting a server listed in panel 704 preferably opens a menu 3804 that includes the following items: properties 3806, start server 3808, stop server 3812, restart server 3814, and remove 3816.

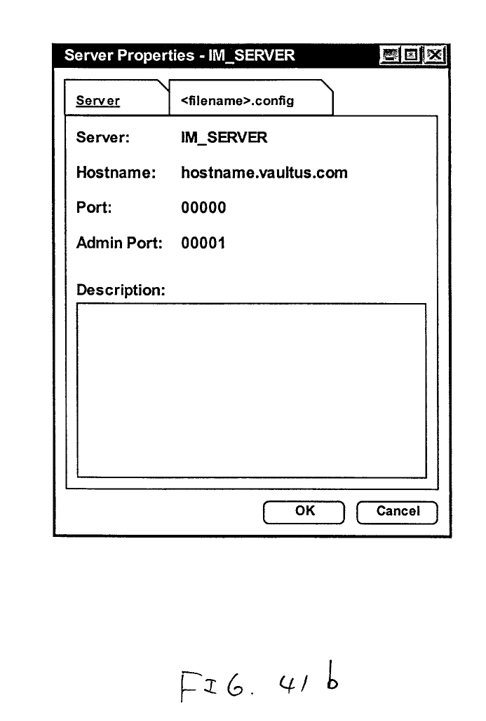

Remove 3816 is used to remove a server. In a preferred embodiment, the system may prompt the administrator with a separate confirmation dialog to confirm removal of each selected server, such as with the dialog shown in FIG. 40. When multiple servers are selected for removal, the confirmation dialog of FIG. 40 may also include a yes to all button to permit the administrator to confirm removal of all selected servers without being shown a confirmation dialog for each.

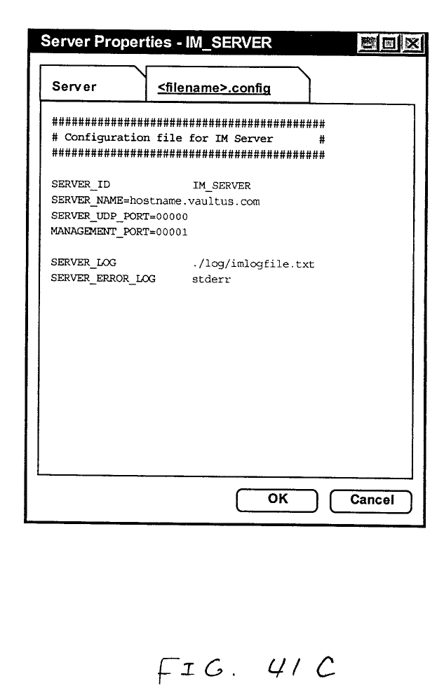

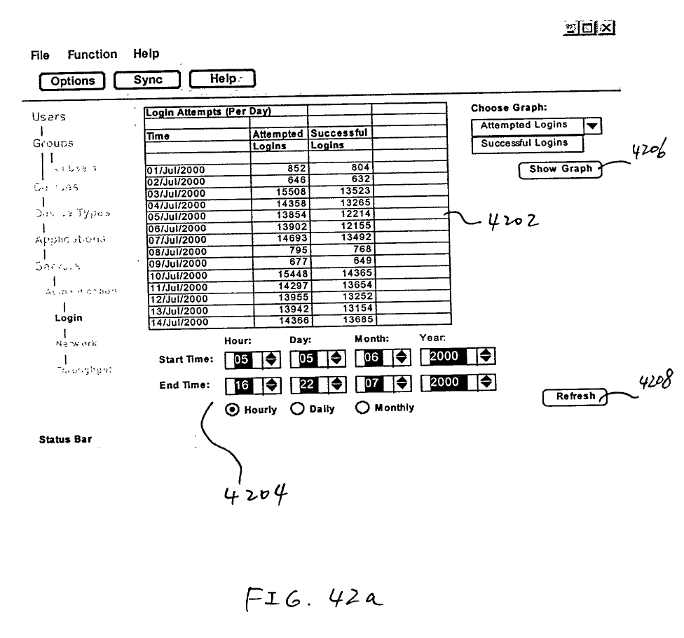

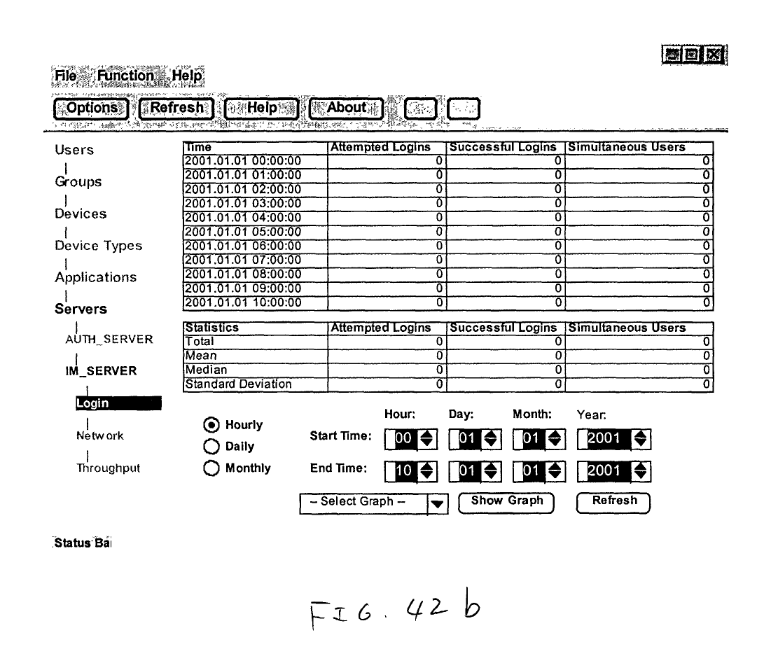

Returning to FIG. 38, selecting properties 3806 causes display of a server properties screen that allows the administrator to edit a server record. A preferred embodiment of this screen is shown in FIG. 41A. As shown in FIG. 41A, the screen preferably comprises editable fields that allow the administrator to edit the server name, hostname, and port. An alternative preferred embodiment of this screen is shown in FIG. 41B. As shown in FIG. 41B, the screen preferably comprises two tabs: “server” and “<filename>.config”. When the tab “server” is selected, as is the case shown in FIG. 41B, the administrator can view information related to the selected server and add descriptions. The “server” label displays the name of the server, the “hostname” label displays the location of the machine that the selected server is running on, the “port” label displays the port number of the machine that the selected server can be contacted on, the “admin port” field displays the port number of the machine that the administrator can be contacted on, and the “description” field displays information to be stored relating to the server. When the tab “<filename>.config” is selected, the screen shown in FIG. 41C is preferably displayed, where the administrator can change the configuration of the selected server.

Returning to FIG. 38, selecting start server 3808 causes a selected server to start. Similarly, selecting stop server 3812 causes the selected server to stop, and selecting restart server 3814 causes the selected server to restart.

Servers 726 in FIG. 38 is preferably expandable to show all servers 304 as children in a tree. Selecting a server in the tree preferably has the same effect as selecting the server from panel 704.

Each server in the tree is also preferably expandable to show children. As shown in FIG. 38, authentication 3822 is expandable and shows 3 children. The 3 children under authentication 3822 are Login 3824, Network 3826, and Throughput 3828. Selecting one of these children preferably has the same effect as selecting a server listed in panel 704, leading to the appearance of panel 3804.

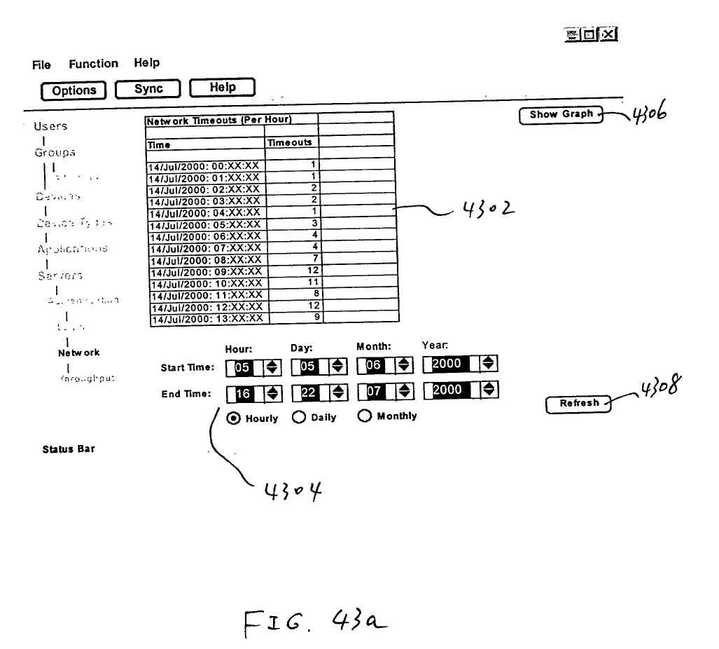

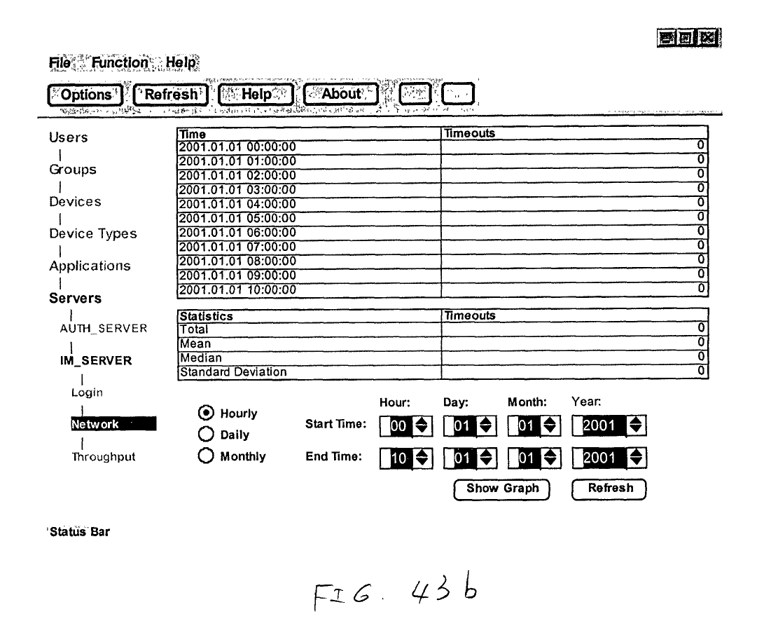

FIG. 42A shows a preferred embodiment of a login properties screen that is displayed when login 3824 is highlighted in FIG. 38 and a properties item (not shown) is selected. This screen allows the administrator to see login information as it relates to a specified server.

As shown in FIG. 42A, this screen preferably comprises a login attempts table 4202 that lists the number of attempted and successful logins for each calendar date within a time period set by an adjustable time table 4204. A show graph button 4206 also allows the data to be displayed in graphical form. Refresh button 4208 updates the information shown in login attempts table 4202.

FIG. 42B shows an alternative preferred embodiment of a login properties screen which displays a list of “simultaneous users” and a table of “statistics.”

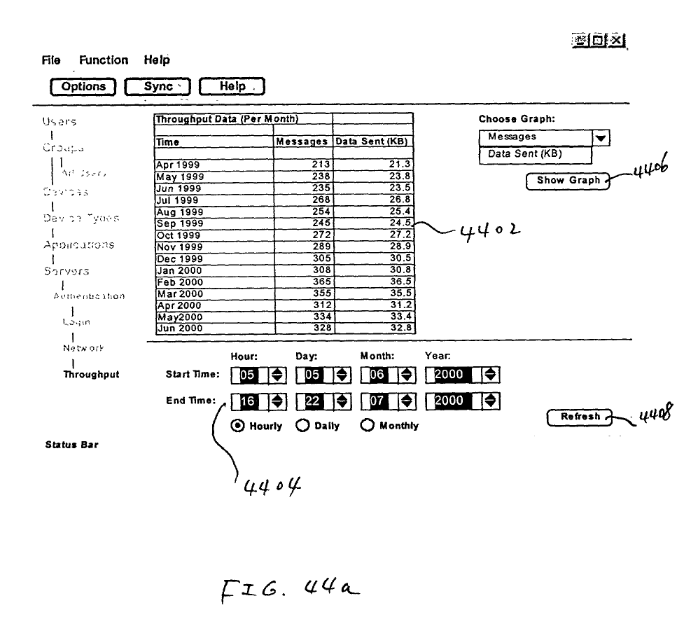

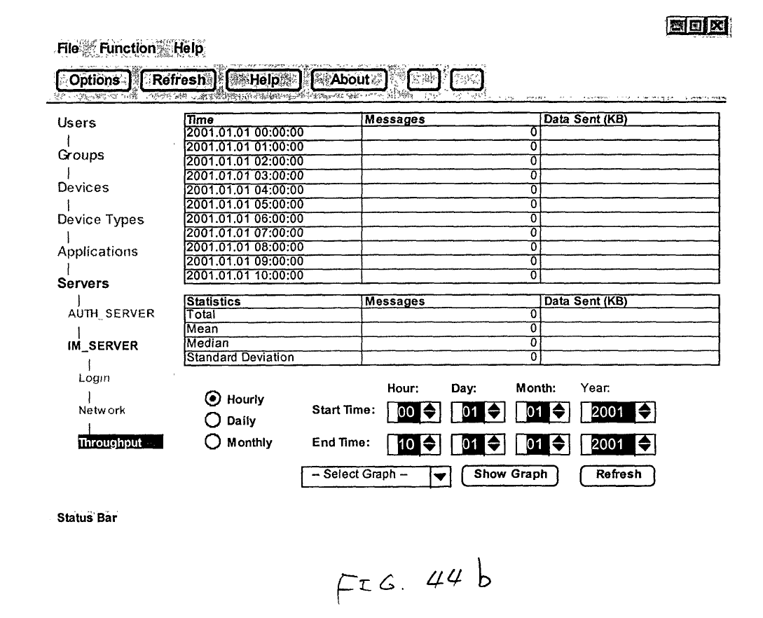

FIG. 43A shows a preferred embodiment of a network properties screen that is displayed when network 3826 in tree 702 is highlighted in FIG. 38 and a properties item (not shown) is selected. This screen allows an administrator to see network information as it relates to a specified server. It preferably comprises a table 4302 that displays the number and time of timeouts within a time period set by an adjustable time table 4304. Show graph button 4306 enables a graphic representation of the data contained in network timeouts table 4302. Refresh button 4308 updates the information shown in network timeouts table 4302. FIG. 43B shows an alternative preferred embodiment of a network properties screen which displays a table of “statistics.”

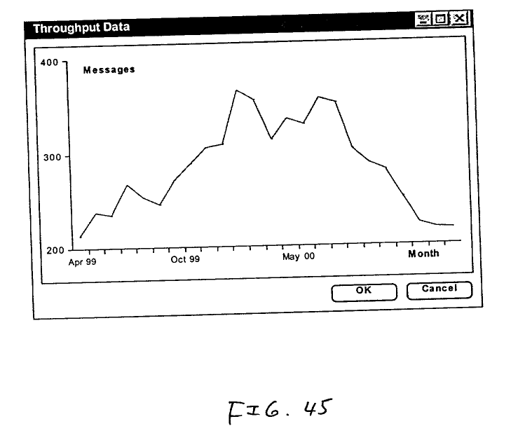

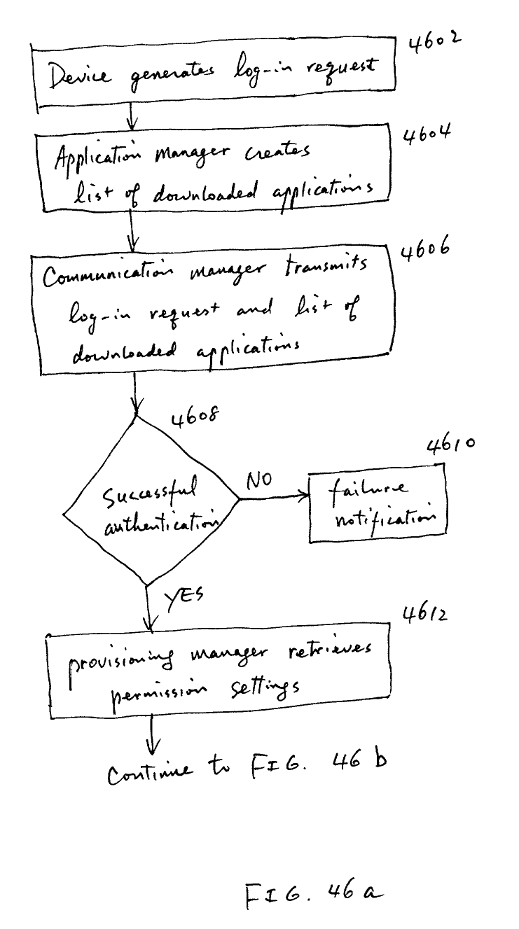

FIG. 44A shows a preferred embodiment of a throughput properties screen that is displayed when throughput 3828 is highlighted in FIG. 38 and a properties item (not shown) is selected. This screen allows an administrator to see throughput information as it relates to a specified server.

As shown in FIG. 44A, this screen preferably comprises a table 4402 that displays througput data for the selected server for the time period set by an adjustable time table 4404. A show graph button 4406 allows the data to be displayed graphically. Refresh button 4408 updates the information shown in throughput data 4402.

FIG. 44B shows an alternative preferred embodiment of a throughput properties screen which displays a table of “statistics.”

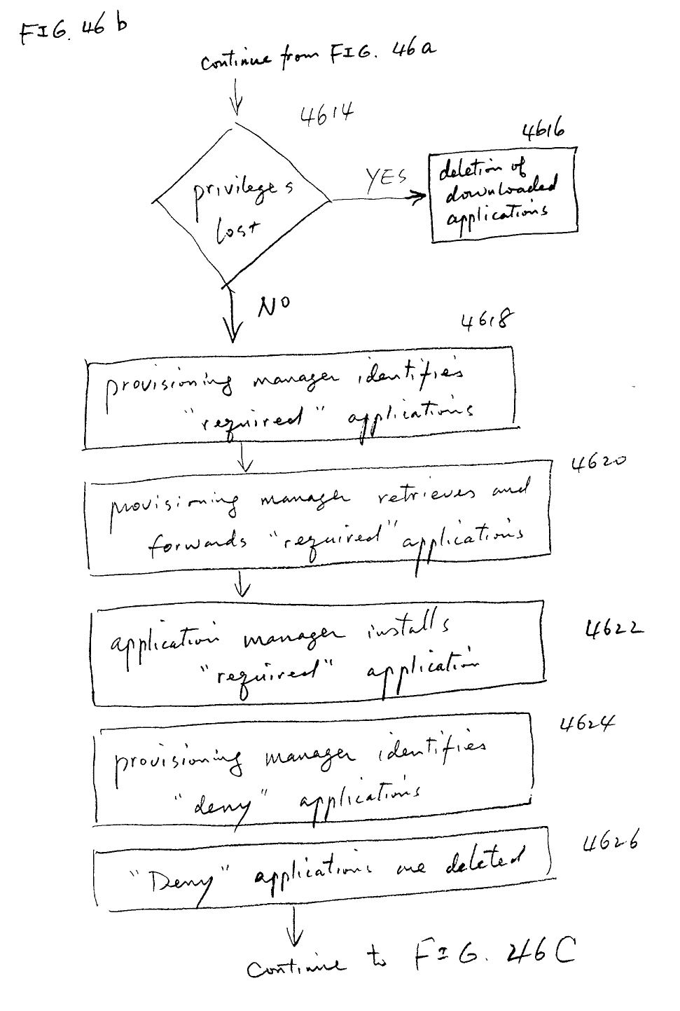

FIG. 45 shows a preferred embodiment of a graphical representation of throughput data which is displayed by selecting show graph button 4406 in FIG. 44A. As shown in FIG. 45, the graph shows a two dimensional plot indicating the number of messages sent between April 1999 and June 2000.

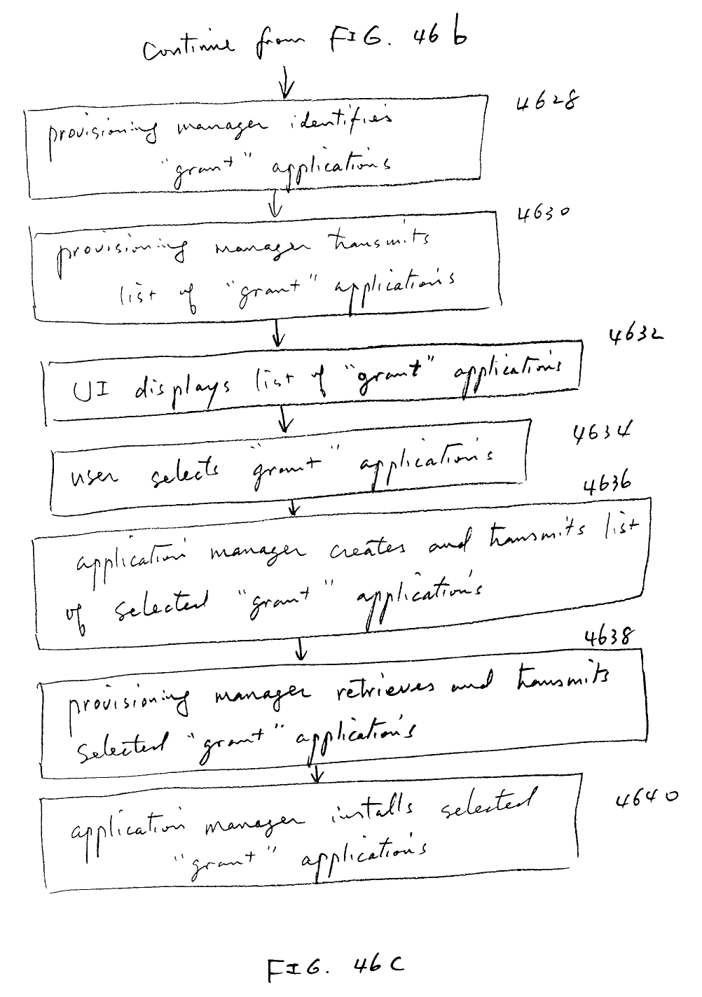

As noted above, for each user category and/or individual user, the administrator preferably assigns each downloaded application 204 to one of four categories: “required,” “grant,” “unspecified,” or “deny.” When a user logs in, “required” applications are automatically downloaded and installed on the user's device. “Grant” applications, on the other hand, are downloaded only if requested by the user. “Deny” applications are deleted from the user's device. A preferred embodiment for provisioning a particular device 106 with an appropriate set of applications during a login session is now described in connection with FIG. 46.

As shown in FIG. 46, in step 4602, device 106 generates a login request to server framework 104. In a preferred embodiment, this login request comprises the unique username of the user carrying device 106 and an associated password which is preferably entered by the user. In step 4604, application manager 208 creates a list of downloaded applications 204 resident on device 106.

In step 4606, the login request and list of resident downloaded applications are transmitted by communication manager 212 to server framework 104 via wireless network 102. Alternatively, the list of applications resident on wireless device 106 may be obtained from the record for the device maintained by the administration tool. In step 4608, an authentication server at server framework 104 authenticates the user using the user's username and password. If the authentication fails, the authentication server generates an appropriate message to device 106 (step 4610), and processing concludes.

If the authentication is successful, flow proceeds to step 4612 where provisioning manager 312 retrieves the permission settings established by the administrator for the user, for any user groups to which the user belongs, and for the user's device type. Provisioning manager 312 uses these permission settings to identify applications that must, may, or may not be downloaded to this user's device.

In particular, in step 4614, provisioning manager 312 determines whether the user has lost system privileges and should no longer be permitted access to server framework 104 or to downloaded applications 204 resident on device 106. If the user has lost system privileges, system flow branches to step 4616, where all downloaded applications on device 106 are deleted. In a first preferred embodiment, this may be accomplished by downloading to device 106 executable code tailored for the particular device 106 that is operative to delete from device 106 all downloaded applications 204 resident on the device. In a second preferred embodiment, executable code for deleting downloaded applications 204 may be previously loaded on device 106 and may be triggered to begin executing by a message from provisioning manager 312.

If the user is still a valid system user, flow proceeds from step 4614 to step 4618 where provisioning manager 312 identifies all applications with permission settings of “required” for this user that are compatible with the user's device 106 and not currently resident on that device. At step 4620, provisioning manager 312 retrieves these applications from application storage 308 and forwards them to device 106 via wireless network 102. Applications may be compressed prior to transmission to decrease required download time. At step 4622, the received applications are installed on device 106 by application manager 208.

At step 4624, provisioning manager 312 identifies all applications with permission settings of “deny” for this user that are on the list of resident downloaded applications received from device 106. At step 4626, these applications are deleted from device 106. As noted above in connection with step 4616, deletion of applications resident on device 106 may be effected by downloading from server framework 104 to device 106 executable software that is operative to delete the applications for which the user is not authorized or by triggering execution of executable software already resident on device 106.

In a preferred embodiment, while the above steps are performed, device 106 displays to the user a login or other screen that has the same appearance and other user interface characteristics that the user would expect to see. In this way, if the system discovers that the user has lost system privileges and/or has unauthorized applications on his or her device 106, the system has the opportunity to delete any unauthorized applications before the user becomes suspicious and attempts to block such deletion.

At step 4628, provisioning manager 312 identifies all applications with permission settings of “grant” that are compatible with the user's device 106 and not currently resident on that device. At step 4630, provisioning manager 312 transmits a list of these applications to device 106 via wireless network 102.

At step 4632, the list of available applications is displayed to the user via UI 202. At step 4634, the user selects the applications on the list that he or she would like to have downloaded by, for example, highlighting them. At step 4636, application manager 208 creates a list of selected applications and transmits them to provisioning manager 312 via wireless network 102. Applications may be compressed prior to transmission to decrease required download time. At step 4638, provisioning manager 312 retrieves the selected applications from application storage 308 and forwards them to device 106 via wireless network 102. At step 4640, the received applications are installed on device 106 by application manager 208.

In a preferred embodiment, all user-specific permission settings override group permission settings, unless the user-specific setting for an application is “unspecified.” Within user and group dialogs, a deny setting always outweighs a required or grant setting. However, a required setting always outweighs a grant setting, which always outweighs an unspecified setting. Table 1 shows some exemplary scenarios and the ultimate permission status applied by the system in deciding whether or not to download a particular application to a particular user.

TABLE 1
Exemplary scenarios of ultimate permission status.

| User: | Group 1: | Group 2: | Result: |
|---|---|---|---|
| Unspecified | Unspecified | Unspecified | Deny |
| Unspecified | Unspecified | Deny | Deny |
| Unspecified | Unspecified | Grant | Grant |
| Unspecified | Unspecified | Required | Required |
| Unspecified | Grant | Deny | Deny |
| Unspecified | Required | Deny | Deny |
| Unspecified | Required | Grant | Required |
| Grant | Unspecified | Deny | Grant |
| Required | Unspecified | Deny | Required |
| Deny | Unspecified | Grant | Deny |
| Deny | Unspecified | Required | Deny |

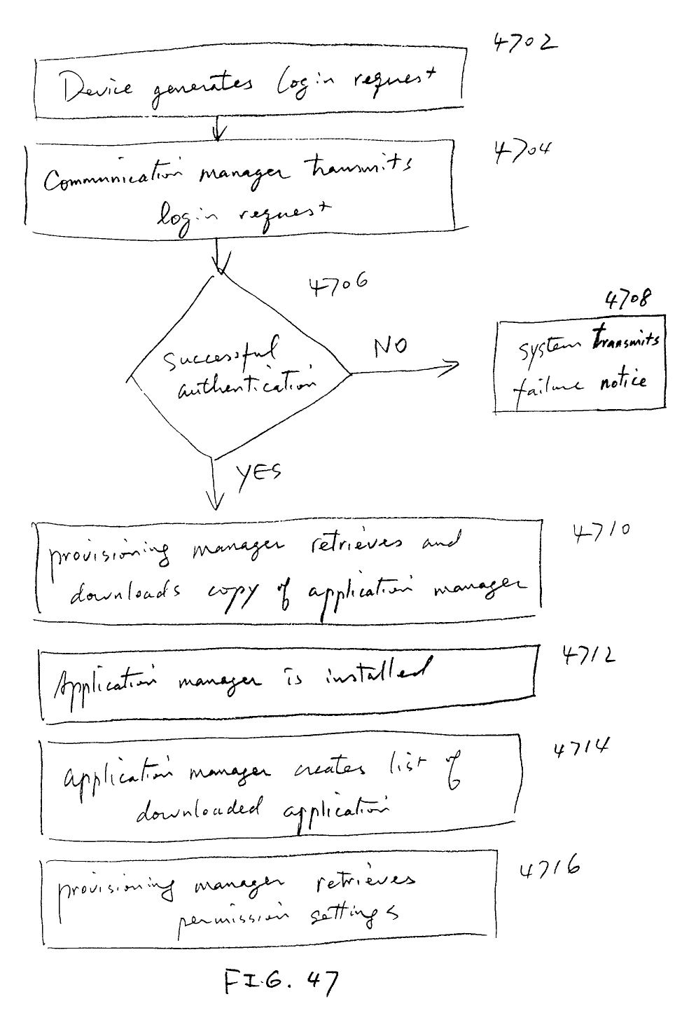

As noted above, application manager 208 may be stored permanently on wireless device 106 or, alternatively, may be downloaded from server framework 104 each time the user initiates a communication session with server framework 104. As will be recognized, when this second alternative is chosen, application manager 208 is not yet resident on device 106 when step 4602 is completed in FIG. 46. Accordingly, in an alternative preferred embodiment, steps 4602-4612 may instead be replaced by steps 4702-4716, shown in FIG. 47. As will be recognized, in this alternative preferred embodiment, application manager 208 is downloaded to device 106 and creates the list of downloaded applications 204 resident on device 106 after the authentication server authenticates the user.

In particular, as shown in FIG. 47, at step 4702, device 106 generates a login request to server framework 104. In a preferred embodiment, this login request comprises the unique username of the user carrying device 106 and an associated password which is preferably entered by the user.

In step 4704, the login request is transmitted by communication manager 212 to server framework 104 via wireless network 102. In step 4706, an authentication server at server framework 104 authenticates the user using the user's username and password. If the authentication fails, the authentication server generates an appropriate message to device 106 (step 4708), and processing concludes.

If the authentication is successful, flow proceeds to step 4710 where application provisioning manager 312 retrieves a copy of application manager 208 from applications storage 308 and downloads it to device 106. At step 4712, application manager 208 is installed on device 106 and begins executing.

In step 4714, application manager 208 creates a list of downloaded applications 204 resident on device 106 and transmits them to application provisioning manager 312 via wireless network 102. In step 4716, application provisioning manager 312 retrieves the permission settings established by the administrator for the user, for any user groups to which the user belongs, and for the user's device type. Processing then continues from step 4614, as described above in connection with FIG. 46.

The following illustrative example is not meant in any way to limit the scope of the present invention, but merely to illustrate operation of the principles articulated above. For purposes of this illustrative example, assume that:

A. The administrator defines two user groups: an engineering group and an accounting group.

B. The administrator assigns permission settings for the following applications:

(1) a first virus-detection application—specified by the administrator as required for all system users (i.e., for members of the all users group);

(2) a second virus-detection application—specified by the administrator as required for all system users (i.e., for members of the all users group);

(3) a first spreadsheet application—specified by the administrator as required for all system users in the accounting group and as unauthorized for all system users in the engineering group; and

(4) a second spreadsheet application—specified by the administrator as required for all system users in the accounting group and as unauthorized for all system users in the engineering group;

(5) a first design application—specified by the administrator as optional for all system users in the engineering group and as unauthorized for all system users in the accounting group.

C. The administrator assigns the following device type permission setting for the above applications: (1) the first virus-detection program is compatible with Palm PDAs but not Handspring PDAs, (2) the second virus-detection program is compatible with Handspring PDAs but not Palm PDAs, (3) the first spreadsheet application is compatible with Palm PDAs but not Handspring PDAs, (4) and the second spreadsheet application is compatible with Handspring PDAs but not Palm PDAs.

If a member of the accounting user group logs into the server framework with a Palm PDA, the system automatically downloads to the user's PDA the first virus-detection program (assuming that this application is not already resident on the PDA) because is required for all system users and is compatible with the user's device. The system also automatically downloads to the user's PDA the first spreadsheet application (assuming that this application is not already resident on the PDA) because it is required for all users in the accounting user group and is compatible with the user's device. The second virus-detection program and second spreadsheet application are not downloaded because they are not compatible with the user's device. The design application is not downloaded because it is unauthorized for users in the accounting user group.

By contrast, if a member of the accounting user group logs into the server framework with a Handspring PDA, the system automatically downloads to the user's PDA the second virus detection program (assuming that this application is not already resident on the PDA) because it is required for all users and is compatible with the user's device. The system also automatically downloads to the user's PDA the second spreadsheet application (assuming that this application is not already resident on the PDA) because it is required for all users in the accounting group and is compatible with the user's device. The first virus-detection program, and the first spreadsheet application are not downloaded because they are not compatible with the user's device. The design application is not downloaded because it is unauthorized for users in the accounting user group.

Finally, if a member of the engineering user group logs into the server framework with a Palm PDA, the system automatically downloads to that PDA the first virus-detection program (assuming that this application is not already resident on the PDA) because it is required for all system users and is compatible with the user's device. The second virus-detection program is not downloaded because it is not compatible with the user's device. The first and second spreadsheet applications are not downloaded because they are unauthorized for users in the engineering user group. The system prompts the user to determine whether he or she wishes to download the design application because it is an optional application for members of the engineering group and is compatible with the user's device. If selected by the user, the system automatically downloads the design application to the user's device.

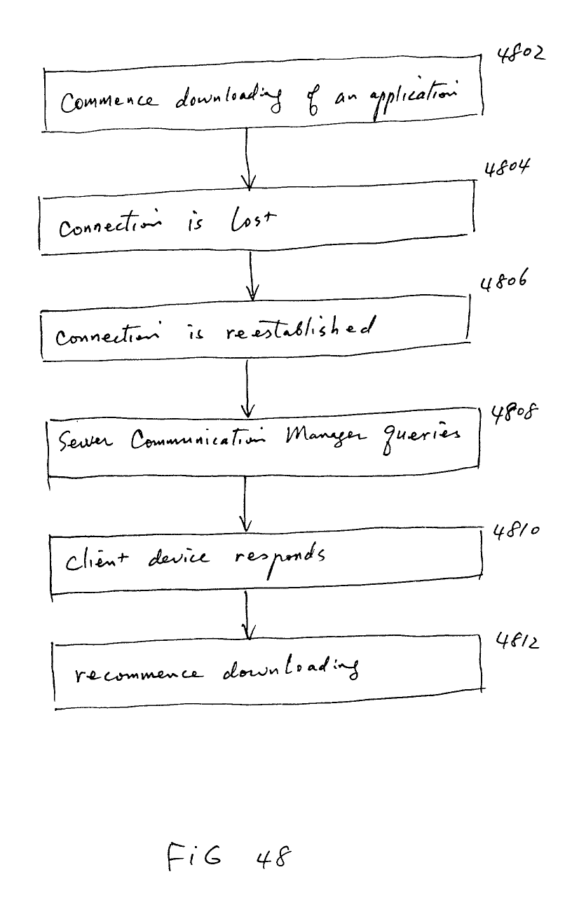

In a preferred embodiment, the system is adapted to successfully provision a client device even if the wireless connection connecting server framework 104 and a client device 106 is temporarily lost during downloading. One illustrative approach for implementing this preferred embodiment is described in connection with the flow chart of FIG. 48. As shown in FIG. 48, in step 4802, downloading of an application is commenced via a connection established between server framework 104 and a client device 106, as explained above. In step 4804, the wireless connection between server framework 104 and client device 106 is lost. In step 4806, the wireless connection between server framework 104 and client device 106 is reestablished. In step 4808, server communication manager 302 queries client device 106 to determine how much of the application was properly received before the connection was lost. In step 4810, client device 106 responds to the query from server communication manager 302. Alternatively, server communication manager 302 may determine how much of the application was properly received before the connection was lost from acknowledgment (ack) messages received from client device 106 during step 4802. In step 4812, server communication manager 302 and application provisioning manager 312 recommence transmission of the application and transmit the remaining portions of the application not received by device 106 before the connection was lost.

While the invention has been described in conjunction with specific embodiments, it is evident that numerous alternatives, modifications, and variations will be apparent to those skilled in the art in light of the foregoing description.

1. A method for managing application provisioning to a wireless device, wherein the wireless device is adapted for use by an end user designated as belonging to an end user class, comprising:
specifying a set of required applications for wireless devices of users belonging to the end user class;
receiving a login request from the wireless device comprising information for identifying and authenticating the end user;
identifying one or more of the required applications that are not resident on the wireless device; and
downloading the identified required applications via a wireless connection from a remote server to the wireless device without end user intervention.

2. The method of claim 1, wherein the user group includes all system users so that the set of required applications are required for all system users.

3. The method of claim 2, wherein the set of required applications includes a virus detection application.

4. The method of claim 2, wherein the set of required applications includes an application that is adapted to display a warning of the proprietary nature of the connection requested.

5. The method of claim 1, wherein the user group includes all users that work for a company in a financial position and the set of required applications for set of required applications comprises an application adapted to access the financial data of the company.

6. The method of claim 1, wherein the user group includes all users that work for a company in a financial position and the set of required applications for set of required applications comprises an application adapted to access he debt records of clients of the company.

7. The method of claim 1, further comprising:
specifying a set of optional applications for wireless devices of users belonging to the end user class;
identifying one or more of the optional applications that are not resident on the wireless device;
displaying a list of the identified optional applications to the user;
receiving a set of requested optional applications from the end user selected from the identified optional applications; and
downloading the requested optional applications via a wireless connection from a remote server to the wireless device.

8. The method of claim 7, wherein the user group includes all users that work for a company in a personnel position and the set of optional applications comprises an application that is adapted to access information about employment candidates of the company.

9. The method of claim 7, wherein the user group includes all users that work for a company in a personnel position and the set of optional applications comprises an application that is adapted to access evaluation information about employment candidates of the company.

10. The method of claim 1, further comprising:
specifying a set of unauthorized applications for wireless devices of users belonging to the end user class;
identifying one or more of the unauthorized applications that are resident on the wireless device; and
deleting the identified unauthorized applications from the wireless device without end user intervention.

11. The method of claim 10, wherein a display screen of the wireless device is adapted to display information to the user such that the user will not realize that the unauthorized applications are being deleted without the user's intervention.

12. A system for managing application provisioning via a wireless network, comprising:
a server framework comprising an authentication server, an application provisioning component, an administration tool, and an application storage that stores one or more applications;
a plurality of wireless devices, each in the possession of a user, the wireless devices each comprising one or more applications and a communications component adapted to communicate with the server framework via the wireless network;
the administration tool adapted to establish and maintain records for a plurality of users, user groups, and device types, and to store:
for each user, permission settings for one or more applications that define whether the application is required, optional, or unauthorized for the user;
for each user group, permission settings for one or more applications that define whether the application is required, optional, or unauthorized for the user group; and
for each device type, permission settings for one or more applications that define whether the application is compatible with a particular device type;
the application provisioning component adapted to apply the permission settings and:
identify required applications that must be downloaded to a wireless device and to automatically download the identified required applications to the wireless device without user intervention;
identify optional applications that may be downloaded to the wireless device and to download the identified optional applications if requested by the user;
identify unauthorized applications that may not be resident on the wireless device and to automatically delete those applications from the wireless device without user intervention.

13. The system of claim 12, wherein one of the user groups includes all system users so that the set of required applications are required for all system users.

14. The system of claim 13, wherein the set of required applications includes a virus detection application.

15. The system of claim 13, wherein the set of required applications includes an application that is adapted to display a warning of the proprietary nature of the connection requested.

16. The system of claim 12, wherein one of the user groups includes all users that work for a company in a financial position and the set of required applications for set of required applications comprises an application adapted to access the financial data of the company.

17. The system of claim 12, wherein one of the user groups includes all users that work for a company in a financial position and the set of required applications for set of required applications comprises an application adapted to access he debt records of clients of the company.

18. The system of claim 12, wherein one of the user groups includes all users that work for a company in a personnel position and the set of optional applications comprises an application that is adapted to access information about employment candidates of the company.

19. The system of claim 12, wherein one of the user groups includes all users that work for a company in a personnel position and the set of optional applications comprises an application that is adapted to access evaluation information about employment candidates of the company.

20. The system of claim 12, wherein a display screen of the wireless device is adapted to display information to the user such that the user will not realize that the unauthorized applications are being deleted without the user's intervention.

21. The system of claim 12, wherein the permission settings for a user dominate the permission settings for a user group to which the user belongs.

22. A method for managing application provisioning to a wireless device, wherein the wireless device is adapted for use by an end user designated as belonging to an end user class, comprising:
specifying a set of required applications for wireless devices of users belonging to the end user class;
specifying a set of optional applications for wireless devices of users belonging to the end user class;
specifying a set of unauthorized applications for wireless devices of users belonging to the end user class;
receiving a login request from the wireless device;
identifying one or more of the required applications that are not resident on the wireless device;
downloading the identified required applications via a wireless connection from a remote server to the wireless device without end user intervention;
identifying one or more of the optional applications that are not resident on the wireless device;
downloading the identified optional applications via a wireless connection from a remote server to the wireless device without end user intervention;
identifying one or more of the unauthorized applications that are resident on the wireless device; and
deleting the identified unauthorized applications from the wireless device without end user intervention.

23. The method of claim 22, wherein the user group includes all system users so that the set of required applications are required for all system users.

24. The method of claim 23, wherein the set of required applications includes a virus detection application.

25. The method of claim 23, wherein the set of required applications includes an application that is adapted to display a warning of the proprietary nature of the connection requested.

26. The method of claim 22, wherein the user group includes all users that work for a company in a financial position and the set of required applications for set of required applications comprises an application adapted to access the financial data of the company.

27. The method of claim 22, wherein the user group includes all users that work for a company in a financial position and the set of required applications for set of required applications comprises an application adapted to access he debt records of clients of the company.

28. The method of claim 22, wherein the user group includes all users that work for a company in a personnel position and the set of optional applications comprises an application that is adapted to access information about employment candidates of the company.

29. The method of claim 22, wherein the user group includes all users that work for a company in a personnel position and the set of optional applications comprises an application that is adapted to access evaluation information about employment candidates of the company.

30. The method of claim 22, wherein a display screen of the wireless device is adapted to display information to the user such that the user will not realize that the unauthorized applications are being deleted without the user's intervention.

31. A system for managing application provisioning via a wireless network, comprising:
a plurality of wireless devices, each in the possession of a user, the wireless devices each comprising one or more applications and a communications component adapted to communicate with a server framework via the wireless network;
an administration tool adapted to establish and maintain records for a plurality of users, user groups, and device types, and to store:
for each user, permission settings for one or more applications that define whether the application is required, optional, or unauthorized for the user;
for each user group, permission settings for one or more applications that define whether the application is required, optional, or unauthorized for the user group; and
for each device type, permission settings for one or more applications that define whether the application is compatible with a particular device type;
an application provisioning component adapted to apply the permission settings and:
identify required applications that must be downloaded to a wireless device and to automatically download the identified required applications to the wireless device without user intervention;
identify optional applications that may be downloaded to the wireless device and to download the identified optional applications if requested by the user; and
identify unauthorized applications that may not be resident on the wireless device and to automatically delete those applications from the wireless device without user intervention.
